(19) United States
(12) Patent Application Publication
(10) Pub. No.: US 2006/0115140 A1
(43) Pub. Date: Jun. 1, 2006

(54) Pattern identification method and identification device

(76) Inventors: Hiroshi Nakamura, Nagano (JP); Keiji Hoson, Nagano (JP)

Correspondence Address: CANTOR COLBURN, LLP, 55 GRIFFIN ROAD SOUTH, BLOOMFIELD, CT, 06002, US

(21) Appl. No.: 10/540,368

(22) PCT Filed: Dec. 17, 2003
(86) PCT No.: PCT/JP03/16234

§ 371 Date: Jun. 23, 2005

(30) Foreign Application Priority Data
Dec. 26, 2002 (JP) 2002-378487
Jun. 25, 2003 (JP) 2003-180356
Jul. 4, 2003 (JP) 2003-192395

(51) Int. Cl. G06K 9/00

(52) U.S. Cl. 382/136; 382/135

(57) ABSTRACT

To provide a pattern identification method and an identification device capable of attaining cost reduction and downsizing of a device and providing a small processing load and low cost when identification processing of an object to be identified or a circular object to be identified is performed with the use of optical image. This method includes picking up an image of the pattern on the surface of an object to be identified (coin, paper money), obtaining output data (step S503) based on the obtained image data, setting previously a selection window (step S505) as a specific selection area in the surface of the object to be identified, extracting the characteristic amount of the image data (steps S506 through S509) by using the total sum value of the output data in the selection area, and then identifying the pattern on the surface of the object to be identified (steps S510 through S512).

### TECHNICAL FIELD

The present invention relates to a pattern identification method and an identification device in which the kind or the genuineness of an object to be identified or a circular object to be identified, which is to be a subject for identification (hereinafter referred to as “object to be identified”), is determined by analyzing the pattern data string of an optical image relating to the characteristic pattern of the object to be identified. Specifically, the present invention relates to a pattern identification method and an identification device in which the identification performance is improved while considering the reduction of load in image processing which is executed when the kind or the genuineness of the object to be identified is determined.

The “object to be identified” means a concept including a circular object to be identified, for example, a coin, a game token or a paper money or the like. In addition, the “circular object to be identified” means an object to be identified having a circular shape, for example, a coin, a game token, or the like.

### BACKGROUND ART

An identification device for determining the kind or the genuineness of an object to be identified such as an inserted coin is commonly provided in various types of apparatuses such as a vending machine, an automatic ticket vendor, a game machine, and a money changing machine, for handling an object to be identified such as a coin or a paper money. In recent years, the forging or altering crime of a coin or a paper money has frequently occurred to cause to be social problems. Therefore, the demand for high functions to the identification device have become increased and various types of identification device have been proposed.

For example, methods in which the pattern identification of a coin is performed by detecting the shape of projections and recesses of the surface of the coin are disclosed in Japanese Patent Laid-Open No. Sho 62-245495, Japanese Patent Laid-Open No. 2001-188932, Japanese Patent Laid-Open No. 2001-188933, Japanese Patent Application No. Sho 61-90547, Japanese Patent Application No. Hei 11-375532, Japanese Patent Application No. Hei 11-375533 or the like. Specifically, in the method disclosed in Japanese Patent Laid-Open No. Sho 62-245495, a sensor disposed at a position where the center of a coin passes through detects the projections and recesses of the shape of the coin, which are collated with the reference pattern of projections and recesses stored in advance to determine the genuineness of the coin by judging whether or not they are coincident with each other.

In Japanese Patent No. 2803930, a method is disclosed in which the denomination or the genuineness is determined by comparing the pattern data, which are obtained from the optical image of the pattern of the surface of the coin that is optically read, with the reference pattern data of the image stored in advance.

In Japanese Patent Laid-Open No. Hei 10-302111 and Japanese Patent No. 2792703, a method is disclosed in which the denomination or the genuineness of a paper money is determined by comparing (pattern matching processing) pattern data, which are obtained from the optical image of the pattern of the surface of the paper money that is optically read, with the reference pattern data of the image stored in advance.

FIG. 22 is an example of a schematic flow chart of a conventional pattern identification method in which the pattern data are obtained from an optical image that is obtained by optically reading the pattern of an object to be identified. In this example, a coin (circular object) is used as an example of an object to be identified.

In the conventional pattern identification method shown in FIG. 22, at first the temporary determination of denomination is performed by detecting the material and the outer diameter of the coin (step S1), and then the final determination of denomination is performed by using the pattern data of the image relating to the pattern of the surface of the coin (step S2).

The procedures for performing the final determination of the denomination will be described below. First, the pattern of the coin C as an object to be identified is optically detected and the optical image of the coin C is obtained, for example, as shown in FIG. 23(a). After that, the horizontal and vertical projections of the optical image are formed to detect the both end points of respective curves and the center position of the coin is obtained from the arithmetic average of the coordinate values. Next, a ring-shaped detection area V including characteristic pattern relating to the kind of the coin C is set on the optical image relating to the pattern of the coin C with the obtained center position as the reference. Then, image pattern data strings are successively cut out along the circumferential direction from the annular area of the optical image corresponding to the ring-shaped detection area V. The cut-out image pattern data string F (evaluation data) is stored as a matrix in a rectangular shape.

Two types of the reference pattern data T₁, T₂ corresponding to the image pattern data string F for front face and rear face having the same size are prepared in advance as the reference data of the coin C which is to be accepted. The image pattern data string F is collated with the two types of reference pattern data T₁, T₂ to calculate their similarities. The collating operations with the reference pattern data T₁, T₂ are respectively performed on the front and rear faces of the coin C as shown in FIGS. 23(b) and 23(c). The normalization correlation coefficient “r” expressed in the following equation is often used as a measure for the similarity obtained from the result.

[Equation 1]

$$r = \frac{{\sum }_{i = 1}^{N} ( {F}_{i} - \overline{F} ) ( {T}_{i} - \overline{T} )}{\sqrt{{\sum }_{i = 1}^{N} {( {F}_{i} - \overline{F} )}^{2}} \sqrt{{\sum }_{i = 1}^{N} {( {T}_{i} - \overline{T} )}^{2}}}$$

In this manner, after the correlation value obtained from a first pixel is set to be “r₁” similar operations are repeated “N” times while a pixel is successively shifted one by one to obtain a series of correlation values (r₁, r₂, . . . r_{N}) The maximum value among the “N” correlation values is detected and set to be the similarity “r”. When the similarity “r” is larger than the threshold value Rₜ which is set in advance, the denomination of the coin which is being estimated is determined to coincide with the temporary determined denomination and accepted as a normal denomination. On the other hand, when the similarity “r” is smaller than the threshold value Rₜ, the denomination of the coin is determined not to coincide with the temporary determined denomination and excluded.

### SUMMARY OF THE INVENTION

However, the above-mentioned pattern identification method has following problems.

First, when a method is utilized in which the identification of a coin is performed by detecting the projections and recesses of the surface of the coin, obtained information is basically limited in a line, i.e., one channel. Therefore, there is a problem that, in order to improve its accuracy, a contrivance is required in which many channels are prepared or a sensor for extracting the quantity of another characteristic is added and thus cost is not reduced.

When a system in which an optical image is used is utilized, image processing steps are required in which a large quantity of pattern data is complicatedly and arithmetically processed. Therefore, in order to ensure practical identification accuracy and processing time, there remains a cost problem that a large capacity of storage element and a high-speed calculation element are required and thus the device will become large and expensive in the end. In addition, the object to be identified such as a coin actually put in or an actually inserted paper money includes a portion where the reflection factor is high due to the smoothness of the surface and a portion where the reflection factor of the characterizing portion of the surface of the coin decreases due to the development of wear or soiling by used history. Therefore, even though the objects to be identified are of the same type, the contrast on the optical image may be extremely varied and thus an image processing step such as a shading processing is also required and it is difficult that the cost reduction and downsizing of a device are attained.

In view of the problems described above, it is an object of the present invention to provide a pattern identification method and an identification device which are capable of reducing the cost and size of the device and reducing load of processing and cost when the identification processing of an object to be identified is performed in the system in which the optical image is utilized.

In order to solve the problems described above, the present invention is characterized in that a specific selection area for the surface of an object to be identified or the like is previously set on output data based on image data obtained by picking up the image of a pattern on the surface of the object to be identified or the like, and the pattern on the surface of the object to be identified or the like is identified by extracting the characteristic amount of the image data with the use of the total sum value of the output data in the selection area.

Further, the present invention is characterized in that a pattern on the surface of a circular object to be identified is identified by specifying output data in a detected section corresponding to a characteristic portion peculiar to the surface of the circular object to be identified on the image data obtained by picking up an image of the pattern on the surface of circular object to be identified with the use of parameters (radius distance and rotation angle) in a polar coordinate system.

More concretely, the present invention provides the following methods.

(1) A pattern identification method for identifying a pattern on the surface of an object to be identified by analyzing output data based on image data obtained by picking up an image of the pattern of the surface of the object to be identified which is an identification object, characterized in that, the pattern identification method comprises previously setting a selection area including a local maximum value or a local minimum value of the output data on the output data, executing total sum operation processing for obtaining total sum value of the output data in the selection area, and then identifying the pattern on the surface of the object to be identified on the basis of the total sum value.

According to the present invention, in the pattern identification method for an object to be identified which utilizes an optical image, a selection area including a local maximum value or a local minimum value of the output data is previously set on the output data which is obtained by processing the image data that is obtained by picking up the image of the object to be identified, a total sum operation processing for obtaining the total sum value of the output data in the selection area is executed, and the pattern on the surface of the object to be identified is identified based on the total sum value. Therefore, a high-speed identification processing is enabled with a simple device.

In other words, a method that requires a high cost is not adopted, in which the identification of an object to be identified is performed by detecting the characteristics of unevenness shape or contrast pattern of the surface of the object to be identified. In the present invention, the method whose basic construction is adding processing is adopted in which the identification of an object to be identified is performed on the basis of the total sum value of pixel values included in a selection area including the characteristic pattern portion of the surface of the object to be identified. Accordingly, the cost and size of the device can be reduced without increasing the burden of processing.

In the present invention, the “object to be identified” includes all objects that are to be an identification object such as a cash voucher such as a check and a traveler's check, an identification card such as a driver's license and a passport, and important documents such as official documents, as well as a coin and a paper money. The characteristic pattern portion of the surface of an object to be identified can be detected, for example, a coin can be detected by the unevenness shape of its surface and an object without unevenness shape such as a paper money can be detected by contrast pattern.

(2) A pattern identification method in which identification of the pattern on the surface of the object to be identified is performed by comparing the total sum value with a prescribed threshold value.

According to the present invention, the identification of the pattern on the surface of the object to be identified is performed by comparing the total sum value with a prescribed threshold value. Therefore, the extraction accuracy of the characteristic amount of the object to be identified can be simply and easily improved and stabilized with a low cost and thus the discrimination performance can be enhanced.

In the present invention, the “prescribed threshold value” is set to be an optimal value by executing the pattern identification method with respect to a genuine object to be identified in accordance with the present invention.

(3) A pattern identification method including picking up the image of the pattern on the surface of an object to be identified which is an identification object, extracting an obtained image data with a prescribed pitch, analyzing output data which are extracted and obtained, and identifying the pattern on the surface of the object to be identified, characterized in that, the pattern identification method further comprises previously setting a selection area including a local maximum value or a local minimum value of the output data on the output data, executing total sum operation processing for obtaining total sum value of the output data in the selection area, obtaining total sum data string which is data string of the total sum value by executing the total sum operation processing whenever the output data and the selection area are relatively shifted with a prescribed pitch, and identifying the pattern on the surface of the object to be identified by analyzing the total sum data string.

According to the present invention, in the pattern identification method for the object to be identified which utilizes an optical image, an image data obtained by picking up the image of the object to be identified is extracted with a prescribed pitch (for example, every five pixels), a selection area including a local maximum value or a local minimum value of the output data is previously set on the output data, a total sum operation processing for obtaining total sum value of the output data in the selection area is executed, a total sum data string which is a data string of the total sum value is obtained by executing the total sum operation processing whenever the output data and the selection area are relatively shifted with the prescribed pitch, and the total sum data string is analyzed. Therefore, only extracted output data are used as an object for identification processing and thus the amount of calculation can be reduced. As a result, a further high speed identification processing can be attained.

Also, the extracted output data and the selection area are relatively shifted, and the data string (total sum data string) that exhibits the peak value is obtained when the characteristic portion of the extracted output data and the selection area are coincided with each other. Therefore, adverse effects due to variation elements (reduction of reflection factor of the characteristic portion of the surface of a coin, wear or stain on the surface of the paper money by use, or the like) on performing the identification processing can be reduced and, as a result, the discrimination performance can be enhanced.

The “prescribed pitch” in the present invention may be defined with a distance in the circumferential direction or with a rotation angle when the object to be identified is, for example, a circular object. For example, when image data are extracted by a pitch with the rotation angle of 5 degrees, the point number of the image data becomes 72 data points in all. Also, when an object to be identified is, for example, a rectangular object, the “prescribed pitch” may be defined with a distance in a major axis direction, a minor axis direction or in a diagonal direction. For example, when ten pixels are extracted with a pitch of one pixel in the minor axis direction and ten pixels are extracted with a pitch of one pixel in the major axis direction, the point number of the image data becomes 100 data points in all.

(4) A pattern identification method including picking up an image of a pattern on the surface of an object to be identified which is an identification object, extracting an obtained image data with a prescribed pitch, analyzing output data which are extracted and obtained, and identifying the pattern on the surface of the object to be identified, characterized in that, the pattern identification method further comprises previously setting a first selection area including a local maximum value of the output data and a second selection area including a local minimum value of the output data on the output data, executing total sum operation processing for obtaining a first total sum value of the output data in the first selection area and a second total sum value of the output data in the second selection area, obtaining a first total sum data string which is data string of the first total sum value and a second total sum data string which is data string of the second total sum value by executing the total sum operation processing whenever the output data and the first selection area and the second selection area are relatively shifted with the prescribed pitch, calculating a difference data string by calculating difference between respective elements of the first total sum data string and respective elements of the second total sum data string corresponding to the respective elements of the first total sum data string, and identifying the pattern on the surface of the object to be identified by analyzing the difference data string.

According to the present invention, in the pattern identification method for the object to be identified which utilizes an optical image, a first selection area including a local maximum value of the output data and a second selection area including a local minimum value of the output data are previously set on the output data, which are obtained by extracting the image data obtained by picking up the image of the object to be identified with the prescribed pitch (for example, every five pixels), a total sum operation processing for obtaining a first total sum value of the output data in the first selection area and a second total sum value of the output data in the second selection area is executed, a first total sum data string which is data string of the first total sum value and a second total sum data string which is data string of the second total sum value are obtained by executing the total sum operation processing whenever the output data and the first selection area and the second selection area are relatively shifted with the prescribed pitch, a difference data string is calculated by calculating difference between respective elements of the first total sum data string and respective elements of the second total sum data string corresponding to the respective elements of the first total sum data string, and the pattern on the surface of the object to be identified is identified by analyzing the difference data string. Therefore, only extracted output data are used as an object for identification processing and thus the amount of calculation can be reduced. As a result, the cost and size of the device can be reduced while further high speed identification processing is attained.

Also, the characteristic amount is extracted from the non-pattern portion on the surface of the object to be identified which is included in the second selection area in addition to the pattern portion of the object to be identified which is included in the first selection area, and the pattern on the surface of the object to be identified is identified by analyzing the difference data string which is subtracted the characteristic amount extracted from the non-pattern portion from the characteristic amount extracted from the pattern portion. Therefore, the characteristic amount extracted from the pattern portion on the surface of the object to be identified is emphasized, and adverse effects due to variation elements such as the decrease of the reflection factor in the characteristic portion can be reduced and, as a result, the cost and size of the device can be reduced while the discrimination performance is enhanced.

(5) A pattern identification method including picking up an image of a pattern on the surface of a circular object to be identified which is an identification object, setting a ring-shaped detection area concentrically with the circular object to be identified on an obtained image data, and identifying the pattern on the surface of the circular object to be identified by analyzing output data which is obtained by extracting image data in the ring-shaped detection area with a prescribed pitch, characterized in that, the pattern identification method further comprises previously setting a selection area including a local maximum value or a local minimum value of the output data on the output data, executing total sum operation processing for obtaining total sum value of the output data in the selection area, obtaining the total sum data string which is data string of the total sum value by executing the total sum operation processing whenever the output data and the selection areas are relatively circulated with the prescribed pitch, and identifying the pattern on the surface of the circular object to be identified by analyzing the total sum data string.

According to the present invention, in the pattern identification method for the object to be identified which utilizes an optical image, a selection area including a local maximum value or a local minimum value of the output data is previously set on the output data comprising of elements in the ring-shaped detection area which is set on the image data obtained by picking up the image of the circular object to be identified, total sum operation processing for obtaining total sum value of the output data in the selection area is executed, the total sum data string which is data string of the total sum value is obtained by executing the total sum operation processing whenever the output data and the selection area are relatively circulated with the prescribed pitch, and the total sum data string is analyzed. Therefore, specifically when an identification object is a circular object such as a coin, only output data composing of elements in the ring-shaped detection area are used as an object for identification processing and thus the amount of calculation can be reduced. As a result, further high speed identification processing can be attained. In other words, the analysis on the characteristic portion of the circular object is directly performed only by basically adding processing. Therefore, high-speed identification processing is enabled with a simple device, and adverse effects due to used history of the circular object are reduced, and thus enhancement of identification performance is attained.

In the present invention, the “ring-shaped detection area” is not limited to a detection area which is in a concentrically circular shape with the circular object to be identified and may be formed in any shape (for example, elliptical shape) having a shape in a concentric with the circular object to be detected and in a specific closed area.

(6) A pattern identification method including picking up an image of a pattern on the surface of a circular object to be identified which is an identification object, setting a ring-shaped detection area concentrically with the circular object to be identified on an obtained image data, and identifying the pattern on the surface of the circular object to be identified by analyzing output data which is obtained by extracting image data in the ring-shaped detection area with a prescribed pitch, characterized in that, the pattern identification method further comprises previously setting a first selection area including a local maximum value of the output data and a second selection area including a local minimum value of the output data on the output data, executing total sum operation processing for obtaining a first total sum value of the output data in the first selection area and a second total sum value of the output data in the second selection area, obtaining a first total sum data string which is data string of the first total sum value and a second total sum data string which is data string of the second total sum value by executing the total sum operation processing whenever the output data and the first selection area and the second selection area are relatively shifted with the prescribed pitch, calculating a difference data string by calculating difference between respective elements of the first total sum data string and respective elements of the second total sum data string corresponding to the respective elements of the first total sum data string, and identifying the pattern on the surface of the object to be identified by analyzing the difference data string.

According to the present invention, in the pattern identification method for the object to be identified which utilizes an optical image, a first selection area including a local maximum value of the output data and a second selection area including a local minimum value of the output data are previously set on the output data comprising of elements in the ring-shaped detection area which is set on the image data obtained by picking up the image of the circular object to be identified, total sum operation processing for obtaining a first total sum value of the output data in the first selection area and a second total sum value of the output data in the second selection area is executed, a first total sum data string which is data string of the first total sum value and a second total sum data string which is data string of the second total sum value are obtained by executing the total sum operation processing whenever the output data and the first selection area and the second selection area are relatively shifted with the prescribed pitch, a difference data string is calculated by calculating difference between respective elements of the first total sum data string and respective elements of the second total sum data string corresponding to the respective elements of the first total sum data string, and the difference data string is analyzed. Therefore, specifically when an identification object is a circular object such as a coin, only output data composing of elements in the ring-shaped detection area are used as an object for identification processing and thus the amount of calculation can be reduced. As a result, further high speed identification processing can be attained. Further, the characteristic amount extracted from the pattern portion on the surface of the circular object can be emphasized, and thus the discrimination performance can be enhanced.

(7) A pattern identification method including setting a plurality ring-shaped detection areas along a radial direction and analyzing a plurality of total sum data strings which are obtained from respective ring-shaped detection areas or a plurality of difference data strings which are obtained from respective ring-shaped detection areas.

According to the present invention, a plurality ring-shaped detection areas are set along a radial direction and a plurality of total sum data strings which are obtained from respective ring-shaped detection areas or a plurality of difference data strings which are obtained from respective ring-shaped detection areas are analyzed. Therefore, the extraction accuracy of the characteristic amount of a coin can be further improved on the basis of a plurality of ring-shaped detection areas and thus the discrimination performance can be enhanced.

(8) A pattern identification method including a first step for inputting the total sum data string or the difference data string as specific input data, a second step for setting a specific selection area including a local maximum value or a local minimum value of the specific input data on the specific input data, a third step for executing specific total sum operation processing which obtains a specific total sum value of the specific input data in the specific selection areas, a fourth step for obtaining a specific total sum data string which is a data string of the specific total sum value by executing the specific total sum operation processing whenever the specific input data and the specific selection area are relatively shifted with a prescribed pitch, and after performing the first through the fourth steps, identifying the pattern on the surface of the object to be identified by analyzing the specific total sum data string.

According to the present invention, after a plurality of processings are successively performed, that is, first, the first step for inputting the above-mentioned total sum data string or the above-mentioned difference data string as specific input data is performed, next, the second step for setting the specific selection area is performed, the third step for executing specific total sum operation processing is performed, and then the fourth step for obtaining specific total sum data string is performed, the analysis of the specific total sum data string obtained in the fourth step is performed. Therefore, the identification accuracy can be improved as well as high-speed identification processing with a simple device.

In other words, according to the above-mentioned present inventions (3) and (8), a pattern identification method can be provided in which, in the pattern identification method described in the invention (3), after the first step inputting the total sum data string as the specific input data is performed, subsequent processings on and after the second step are performed to identify the pattern on the surface of the object to be identified.

Also, according to the above-mentioned present inventions (4) and (8), a pattern identification method can be provided in which, in the pattern identification method described in the invention (4), after the first step inputting the difference data string as the specific input data is performed, subsequent processings on and after the second step are performed to identify the pattern on the surface of the object to be identified.

Further, according to the above-mentioned present inventions (5) and (8), a pattern identification method can be provided in which, in the pattern identification method described in the invention (5), after the first step inputting the total sum data string as the specific input data is performed, subsequent processings on and after the second step are performed to identify the pattern on the surface of the object to be identified.

Further, according to the above-mentioned present inventions (6) and (8), a pattern identification method can be provided in which, in the pattern identification method described in the invention (6), after the first step inputting the difference data string as the specific input data is performed, subsequent processings on and after the second step are performed to identify the pattern on the surface of the object to be identified.

In this manner, the pattern may be identified by analyzing an “i”-th specific total sum data string (“i” is 2 or more) which is obtained by further repeating processing “A” to the “total sum data string” in the above-mentioned present inventions (3) and (5) or the “difference data string” in the above-mentioned present inventions (4) and (6) like ‘specific selection area setting’→‘(a second) specific total sum operation processing’→‘(a second) specific total sum data string’ (above-mentioned processings are defined as the processing “A”)→‘specific selection area setting in (the second) specific total sum data string’→‘(a third) specific total sum operation processing’→‘(a third) specific total sum data string’→ . . . (repeated). Alternatively, the pattern may be identified by analyzing an “i”-th specific difference data string (“i” is 2 or more) which is obtained by further repeating processing “B” to the “total sum data string” in the above-mentioned present inventions (3) and (5) or the “difference data string” in the above-mentioned present inventions (4) and (6) like ‘the first and the second specific selection areas setting’→‘(a second) specific total sum operation processing’→‘(a second) specific total sum data string’→‘(a second) specific difference data string’ (above-mentioned processings are defined as the processing “B”)→‘the first and the second specific selection areas setting in (the second) specific difference data string’→‘(a third) specific total sum operation processing’→‘(a third) specific total sum data string’→‘(a third) specific difference data string’ . . . (repeated). Alternatively, the pattern may be identified by analyzing the “i”-th specific total sum data string or the “i”-th specific difference data string which are obtained by combining the processing “A” and the processing “B” like the processing “A” →the processing “B” →the processing “A” →or the processing “A”→the processing “B”→the processing “B”. According to the methods described above, the identification accuracy can be improved.

(9) A pattern identification method including repeatedly performing processings from the second step through the fourth step a plurality of times with the specific total sum data string as the specific input data, and then identifying the pattern on the surface of the object to be identified by analyzing the specific total sum data string.

According to the present invention, analysis of the specific total sum data string is performed after repeatedly performing processings from the second step through the fourth step a plurality of times with the specific total sum data string as the specific input data. Therefore, the identification accuracy can be further improved in addition to high-speed identification processing with a simple device.

(10) A pattern identification method includes a first step for inputting the total sum data string or the difference data string as specific input data, a second step for setting a first specific selection area including a local maximum value of the specific input data and a second specific selection area including a local minimum value of the specific input data on the input data, a third step for executing a specific total sum operation processing which obtains a first specific total sum value of the specific input data in the first specific selection area and a second specific total sum value of the specific input data in the second specific selection area, a fourth step for obtaining a first specific total sum data string which is a data string of the first specific total sum value and a second specific total sum data string which is a data string of the second specific total sum value by executing the specific total sum operation processing whenever the specific input data and the first specific selection area and the second specific selection area are relatively shifted with a prescribed pitch, a fifth step for calculating a specific difference data string by calculating a difference between respective elements of the first specific total sum data string and respective elements of the second specific total sum data string corresponding to the respective elements of the first specific total sum data string, and after performing the first through the fifth steps, identifying the pattern on the surface of the object to be identified by analyzing the specific difference data string.

According to the present invention, after a plurality of processings are successively performed, that is, first, the first step for inputting the above-mentioned total sum data string or the above-mentioned difference data string as specific input data is performed, next, the second step for setting the first specific selection area and the second specific selection area is performed, the third step for executing specific total sum operation processing is performed, the fourth step for obtaining the first specific total sum data string and the second specific total sum data string is performed, and then the fifth step for calculating the specific difference data string, the analysis of the specific difference data string obtained in the fifth step is performed. Therefore, the identification accuracy can be improved as well as high-speed identification processing with a simple device.

(11) A pattern identification method including obtaining the specific difference data string as the specific input data by repeatedly performing processings from the second step through the fifth step a plurality of times, and then identifying the pattern on the surface of the object to be identified by analyzing the specific difference data string.

According to the present invention, the specific difference data string is analyzed, which is obtained after the processings from the second step through the fifth step are repeatedly performed a plurality of times with the specific difference data string as the specific input data. Therefore, the identification accuracy can be improved as well as high-speed identification processing with a simple device.

(12) A pattern identification method including obtaining the specific total sum data string or the specific difference data string as the specific input data by repeatedly performing a plurality of times the processings from the second step through the fourth step described in the above-mentioned invention (8) or the processings from the second step through the fifth step described in the above-mentioned (10) and then identifying the pattern on the surface of the object to be identified by analyzing the specific total sum data string or the specific difference data string.

According to the present invention, the specific total sum data string or the specific difference data string is analyzed, which is obtained after the processings from the second through the fourth steps described in the above-mentioned invention (8) or the processings from the second through the fifth steps described in the above-mentioned invention (10) are repeatedly performed a plurality of times with the specific total sum data string or the specific difference data string as the specific input data. Then the specific total sum data string or the specific difference data string is analyzed. Therefore, the identification accuracy can be improved as well as high-speed identification processing with a simple device.

(13) A pattern identification method including analyzing of the total sum data string, the specific total sum data string, the difference data string or the specific difference data string, wherein the analyzing is performed by detecting a peak value of the total sum data string, the specific total sum data stream, the difference data string or the specific difference data string, and then comparing the detected peak value with a prescribed threshold value.

According to the present invention, the analysis method of total sum data string is that the peak value of total sum data string is detected and the detected peak value is compared with a prescribed threshold value. Alternatively, the analysis method of specific total sum data string is that the peak value of specific total sum data string is detected and the detected peak value is compared with a prescribed threshold value. Alternatively, the analysis method of difference data string is that the peak value of difference data string is detected and the detected peak value is compared with a prescribed threshold value. Alternatively, the analysis method of specific difference data string is that the peak value of specific difference data string is detected and the detected peak value is compared with a prescribed threshold value. Therefore, the extraction accuracy of the characteristic amount of an object to be identified and a circular object to be identified can be simply and easily improved and stabilized with a low cost and, as a result, the discrimination performance can be enhanced.

(14) A pattern identification method including analyzing the total sum data string, the specific total sum data string, the difference data string or the specific difference data string, wherein the analyzing is performed by counting the peak values of the total sum data string, the specific total sum data stream, the difference data string or the specific difference data string, and comparing the total number of which the peak values are counted with a prescribed threshold value.

According to the present invention, the analysis method of the total sum data string is that the peak values of the total sum data string are counted and the total number of the counted peak values is compared with a prescribed threshold value. Alternatively, the analysis method of the specific total sum data string is that the peak values of specific total sum data string are counted and the total number of the counted peak values is compared with a prescribed threshold value. Alternatively, the analysis method of the difference data string is that the peak values of difference data string are counted and the total number of the counted peak values is compared with a prescribed threshold value. Alternatively, the analysis method of the specific difference data string is that the peak values of specific difference data string are counted and the total number of the counted peak values is compared with a prescribed threshold value. Therefore, the extraction accuracy of the characteristic amount of an object to be identified and a circular object to be identified can be simply and easily improved and stabilized with a low cost and, as a result, the discrimination performance can be enhanced.

(15) A pattern identification method including analyzing the total sum data string, the specific total sum data string, the difference data string or the specific difference data string, wherein the analyzing is performed by comparing an entire total sum data string, an entire specific total sum data string, an entire difference data string or an entire specific difference data string with a reference total sum data string or a reference difference data string which is previously set.

According to the present invention, the analysis method of the total sum data string is that an entire total sum data string is compared with a reference total sum data string which is previously set. Alternatively, the analysis method of the specific total sum data string is that an entire specific total sum data string is compared with a reference total sum data string which is previously set. Alternatively, the analysis method of the difference data string is that an entire difference data string is compared with a reference difference data string which is previously set. Alternatively, the analysis method of the specific difference data string is that an entire specific difference data string is compared with a reference difference data string which is previously set. Therefore, the extraction accuracy of the characteristic amount of an object to be identified and a circular object to be identified can be simply and easily improved and stabilized with a low cost and, as a result, the discrimination performance can be enhanced.

(16) A pattern identification method including analyzing the total sum data string, the specific total sum data string, the difference data string or the specific difference data string, wherein the analyzing includes detecting the peak value of the total sum data string, the specific total sum data string, the difference data string or the specific difference data string, obtaining the average value of the total sum data string, the specific total sum data string, the difference data string or the specific difference data string, and comparing the value, which is subtracted the average value of the total sum data string, the specific total sum data string, the difference data string or the specific difference data string from the peak value of the total sum data string, the specific total sum data string, the difference data string or the specific difference data string, with a prescribed threshold value.

According to the present invention, the analysis method of the total sum data string is that the value which is subtracted the average value of the output level of the total sum data string from the peak value of the total sum data string is compared with a prescribed threshold value. Alternatively, the analysis method of the specific total sum data string is that the value which is subtracted the average value of the output level of the specific total sum data string from the peak value of the specific total sum data string is compared with a prescribed threshold value. Alternatively, the analysis method of the difference data string is that the value which is subtracted the average value of the output level of the difference data string from the peak value of the difference data string is compared with a prescribed threshold value. Alternatively, the analysis method of the specific difference data string is that the value which is subtracted the average value of the output level of the specific difference data string from the peak value of the specific difference data string is compared with a prescribed threshold value. Therefore, even when the reflection factor in the characteristic portion of the surface of an object to be identified or a circular object to be identified is generally reduced, the extraction accuracy of the characteristic amount of the object to be identified or the circular object to be identified can be stabilized and, as a result, the discrimination performance can be enhanced.

(17) A pattern identification method including picking up an image of a pattern on the surface of a circular object to be identified which is an identification object, setting a detection area on an obtained image data, and identifying the pattern on the surface of the circular object to be identified by analyzing output data which is obtained by extracting image data in the detection area, characterized in that, the pattern identification method further comprises previously setting the characteristic portion peculiar to a prescribed normal circular object by using a radius distance “r” from the center position O and a rotation angle θ₀ of the normal circular object when the normal circular object is placed at a prescribed rotational position and the circular object to be identified is the prescribed normal circular object, detecting a rotation angle θ of the circular object to be identified with respect to the prescribed rotational position of the normal circular object, and identifying the pattern on the surface of the circular object to be identified by analyzing output data specified by the rotation angle θ₀, the radius distance “r” and the rotation angle θ.

According to the present invention, in the pattern identification method using an image data obtained by picking up an image of a pattern on the surface of a circular object to be identified which is an identification object, after at least a characteristic portion peculiar to a normal circular object is previously set by using a radius distance “r” and a rotation angle θ₀ from a prescribed rotational position, which are parameters in a polar coordinate system, a rotation angle θ is detected which indicates how many degrees the circular object to be identified is rotated from the prescribed rotational position, and then the pattern of the circular object to be identified is identified by using the output data in the detected section of the image data which is specified by the three parameters of “r”, θ₀ and θ. Therefore, the discrimination performance can be improved.

In other words, in the conventional method, a large quantity of pattern data is extracted from image data and complicated arithmetic processing is applied to them. Therefore, expensive elements are required in order to ensure practical identification accuracy and processing time, and thus the entire device becomes expensive. However, according to the present invention, the identification processing is performed in the only characteristic portion peculiar to the circular object and thus high-speed processing can be realized.

Further, even when the reflection factor of the characteristic portion of the entire surface of the circular object is reduced due to, for example, stain adhered on the surface of the circular object or wear of the circular object with a long time used history, the identification processing is performed only in the characteristic portion peculiar to the circular object. Therefore, adverse effects due to variation elements in the coin is reduced and, as a result, the extraction accuracy of the characteristic amount of the object to be identified can be stabilized and the discrimination performance can be enhanced.

In the present invention, the “prescribed rotational position” of a normal circular object is used for setting of the rotation angle θ₀ and the detection of the rotation angle θ. For example, when the normal circular object is a 100-yen coin, the “prescribed rotational position” means the rotational position at which the character of [symbol] is positioned uppermost (position at 12 o'clock) among the character string of [symbol] and

[symbol]

(18) A pattern identification method in which the characteristic portion includes a first characteristic portion having a characteristic pattern of the normal circular object and a second characteristic portion not having the characteristic pattern of the normal circular object, and difference data between a first output data obtained corresponding to the first characteristic portion and a second output data obtained corresponding to the second characteristic portion are obtained, and the pattern on the surface of the circular object to be identified is identified by comparing the difference data with a prescribed threshold value.

According to the present invention, the characteristic portion peculiar to a circular object includes a portion including a characteristic pattern (a first characteristic portion) of the normal circular object and a portion not having the characteristic pattern (a second characteristic portion) of the normal circular object, and identification is performed by comparing the difference data which is subtracted the second output data obtained corresponding to the second characteristic portion from the first output data obtained corresponding to the first characteristic portion with the prescribed threshold value. Therefore, the discrimination performance can be further improved.

In other words, the identification method of the present invention in which the difference data are compared with the prescribed threshold value represents a remarkable difference in the pattern of the circular object to be identified in comparison with the identification method in which only the first output data on the image data obtained in correspondence with the first characteristic portion is compared with the prescribed threshold value, and thus the pattern of the circular object can be identified with a high degree of accuracy.

Moreover, the first characteristic portion and the second characteristic portion may be single or plural and, when plural, identification is performed by comparing difference data subtracted the total sum of the second output data from the total sum of the first output data with the prescribed threshold value. Therefore, identification can be basically performed only by addition and subtraction processing and identification processing with a light processing burden can be performed at a high speed and low cost.

(19) A pattern identification method including a detection method of the rotation angle θ, wherein the detection method includes previously setting a ring-shaped detection area concentrically with the circular object to be identified on the image data, previously setting a first selection area including a local maximum value of the output data and a second selection area including a local minimum value of the output data on the output data which are obtained by extracting image data in the ring-shaped detection area by a prescribed pitch, executing a total sum operation processing for obtaining a first total sum value of the output data in the first selection area and a second total sum value of the output data in the second selection area, obtaining a first total sum data string which is a data string of the first total sum value and a second total sum data string which is a data string of the second total sum value by executing the total sum operation processing whenever the output data and the first selection area and the second selection area are relatively circulated with a prescribed pitch, calculating a difference data string by calculating a difference between respective elements of the first total sum data string and respective elements of the second total sum data string corresponding to the respective elements of the first total sum data string, and detecting the rotation angle by analyzing the difference data string.

According to the present invention, the method for detecting the rotation angle θ includes previously setting a first selection area including a local maximum value and a second selection area including a local minimum value on the output data comprising of elements in the ring-shaped detection area set on the image data, executing a total sum operation processing for obtaining a first total sum value of the output data in the first selection area and a second total sum value of the output data in the second selection area, obtaining a first total sum data string which is a data string of the first total sum value and a second total sum data string which is a data string of the second total sum value by executing the total sum operation processing whenever the output data and the first selection area and the second selection area are relatively circulated with a prescribed pitch, calculating a difference data string by subtracting respective elements of the second total sum data string corresponding to the respective elements of the first total sum data string from respective elements of the first total sum data string, and detecting by analyzing the difference data string. Therefore, the rotation angle θ can be detected without canceling the merit of the present invention based on addition and subtraction processing contributing to the identification at a high speed and low cost and, as a result, the identification method that can improve the discrimination performance can be realized.

(20). A pattern identification method including identifying the pattern on the surface of the circular object to be identified by comparing data which are added or subtracted the difference data to or from the peak value of the difference data string with a prescribed threshold value.

According to the present invention, identification is performed by comparing data which are added or subtracted the difference data, which are subtracted the total sum of the second output data from the total sum of the first output data, to or from the peak value of the difference data string, which is obtained when the rotation angle θ is detected, with a prescribed threshold value. Therefore, when the circular object to be identified is a genuine coin, the characteristic amount (peak value) obtained from the difference data can be emphasized and, as a result, the discrimination performance can be improved.

The reason of that the difference data are “added or subtracted” from the peak value of the difference data string is that the peak value of the difference data string may be the minimum value instead of the maximum value. In other words, when illumination with a small irradiation angle is used, the output value becomes large in the pattern portion of the surface of the coin and thus the maximum value of the difference data string becomes the peak value. On the other hand, when illumination with a large irradiation angle is used, the output value becomes large in the non-pattern portion of the surface of the coin and thus the minimum value of the difference data string becomes the peak value. Therefore, the emphasis of characteristic amount is enabled by “adding” the difference data, which is subtracted the total sum of the second output data from the total sum of the first output data, when the maximum value of the difference data string becomes the peak value. On the other hand, the emphasis of characteristic amount is enabled by “subtracting” the difference data which is subtracted the total sum of the second output data from the total sum of the first output data when the minimum value of the difference data string becomes the peak value. Accordingly, the discrimination performance can be improved.

(21) A pattern identification method including specifying the output data while at least one of parameters of the rotation angle θ₀, the radius distance “r” and the rotation angle θ is slightly varied.

According to the present invention, the output data are specified while at least one of three parameters of “r”, θ₀ and θ is slightly varied. Therefore, the detecting deviation of the characteristic position of a circular object can be amended and, as a result, the extraction accuracy of the characteristic amount can be stabilized.

In the present invention, the “specifying while slightly varied” means that the above mentioned identification method is executed after the center point obtained by shifting the center point of the circular object with several pixels in an X-axis direction or a Y-axis direction is determined as the center point for correction and the processings are repeatedly performed to specify. Alternatively, the “specifying while slightly varied” means that the above mentioned identification method is executed after the angle by shifting the rotation angle θ of the circular object with several degrees is determined as the rotation angle for correction and the processings are repeatedly performed to specify. The detecting deviation of the center point or the rotation angle can be amended by identifying the maximum value or the minimum value of the difference data obtained by the above mentioned processings as the characteristic amount of the circular object to be identified and, as a result, the discrimination performance can be improved.

(22) A pattern identification method for determining genuineness of an object to be identified or a circular object to be identified by using the pattern identification method according to either one of the inventions (1) through (21).

According to the present invention, the genuineness of an object to be identified or the genuineness of a circular object to be identified is determined by using the above-mentioned pattern identification method and thus, for example, the forgery or alteration such as a coin or a paper money can be accurately detected in a short time.

(23) An identification device including an identification means for identifying a pattern on the surface of an object to be identified or a circular object to be identified by using the pattern identification method according to either one of the inventions (1) through (21).

According to the present invention, the identification device for an object to be identified or a circular object to be identified includes an identification means with the use of the identification method described above. Therefore, the identification device for an object to be identified, in which high-speed processing and low cost are realized and whose discrimination performance is enhanced, can be provided.

(24) An identification device including a genuineness decision means for determining genuineness of an object to be identified or a circular object to be identified by an identification result of the identification means.

According to the present invention, the pattern on the surface of the object to be identified and the circular object to be identified is identified by using the above-mentioned pattern identification method and then the genuineness decision means determines the genuineness of the object to be identified or the genuineness of the circular object to be identified by the identification result. Therefore, for example, the forgery or alteration such as a coin or a paper money can be accurately detected in a short time.

As described above, in a pattern identification method and an identification device in accordance with the present invention, the selection area peculiar to the surface of the object to be identified is previously set on the output data based on the image data which are obtained by picking up the image of the surface of the object to be identified, and the characteristic amount of the image data is extracted by using the total sum value of the output data in the selection area. The identification processing is basically comprised of addition and subtraction and a DSP and the dedicated hardware which have been conventionally needed are not required. Therefore, identification algorithm can be mounted at a low cost and thus the cost reduction and downsizing of the device can be attained.

Further, according to the present invention, the output data of the detected section corresponding to the characteristic portion peculiar to the surface of the circular object are specified by using two parameters of a radius distance and a rotation angle, and then the pattern on the surface of the circular object to be identified is identified. Therefore, adverse effects due to variation elements such as the state of a coin can be reduced and thus the pattern identification method and the identification device in which discrimination performance can be improved can be provided. In addition, according to the present invention, the pattern of the circular object can be identified by basically performing only addition and subtraction processing. Therefore, the pattern identification method and the identification device, which are capable of performing identification processing with light processing burden and at a high speed and low cost, can be provided.

### BRIEF DESCRIPTION OF THE DRAWINGS

FIG. 1 is a plan view showing a schematic construction of a coin feeding path which is provided inside of an identification device in accordance with a first and a third embodiments of the present invention.

FIG. 2 is a side cross-sectional view showing the coin feeding path which is provided inside of the identification device in accordance with the first and the third embodiments of the present invention.

FIG. 3 is an enlarged side view showing a schematic construction of an optical coin sensor device which is provided inside of the identification device in accordance with the first and the third embodiments of the present invention.

FIG. 4 is a plan view showing a schematic construction of a paper money feeding path which is provided inside of an identification device in accordance with a second embodiment of the present invention.

FIG. 5 is a block diagram showing an electric construction of the identification device in accordance with the first and the third embodiments of the present invention.

FIG. 6 is a flow chart showing a pattern identification method in accordance with the first embodiment of the present invention.

FIG. 7 is a view showing an example of the optical image of a circular object (coin) to be put into the identification device in accordance with the first embodiment of the present invention.

FIG. 8 is a view showing a state in which selective windows are set on the optical image of a circular object (coin) to be put into the identification device in accordance with the first embodiment of the present invention.

FIG. 9 is a flow chart showing a subroutine inserted between processing in the step S508 and processing in the step S510 which are shown in the flow chart of FIG. 6.

FIG. 10 is a flow chart showing another pattern identification method in accordance with the first embodiment of the present invention.

FIG. 11 is a flow chart showing another pattern identification method in accordance with the first embodiment of the present invention.

FIG. 12 is a flow chart showing a pattern identification method in accordance with the second embodiment of the present invention.

FIG. 13 is a view showing an example of the optical image of a rectangular object (paper money), which is inserted into an identification device in accordance with the second embodiment of the present invention.

FIG. 14(a) is a view showing a state in which selection windows are set on the optical image of the rectangular object (paper money) inserted into the identification device in accordance with the second embodiment of the present invention.

FIG. 14(b) is a waveform diagram showing the output of a level value when a selected area is located at the position shown in FIG. 14(a).

FIG. 15(a) is a view showing a state in which money data are scanned, that are obtained from the optical image of the rectangular object (paper money) inserted into the identification device in accordance with the second embodiment of the present invention.

FIG. 15(b) is a waveform diagram showing difference data obtained by a subtraction processing with respect to relative moving amount of the selected area.

FIG. 15(c) is a waveform diagram showing an one-dimensional difference data string for relative moving amount of the selected areas.

FIG. 16 is a flow chart showing a pattern identification method in accordance with a third embodiment of the present invention.

FIG. 17 is a view showing a state in which characterizing portions are set on the optical image of a genuine circular object (coin), which is put into the pattern identification device in accordance with the third embodiment of the present invention.

FIG. 18 is a view showing a state in which output data corresponding to the characterizing portions are specified on the optical image of a circular object (coin), which is put into the pattern identification device in accordance with the third embodiment of the present invention.

FIG. 19(a) is a view showing a state in which a ring-shaped detection area, positive windows W_{P} and negative windows W_{N} are set on an optical image of the surface of a coin which is to be accepted.

FIG. 19(b) is a view showing a corresponding relationship between the histogram of ring data D and the respective windows obtained from the optical image in FIG. 19(a).

FIG. 19(c) is a graph showing a total sum value S_{P} for shifted amount of the ring data D obtained from the optical image in FIG. 19(a).

FIG. 19(d) is a graph showing a total sum value S_{N} for shifted amount of the ring data D obtained from the optical image in FIG. 19(a).

FIG. 19(e) is a graph showing the difference data string ΔL for shifted amount of the ring data D obtained from the optical image in FIG. 19(a).

FIG. 19(f) is a view showing a corresponding relationship between the histogram of the ring data D and the respective windows obtained from the optical image of the surface of a coin that is to be rejected.

FIG. 19(g) is a graph showing the difference data string ΔL for shifted amount of the ring data D obtained from the optical image in FIG. 19(f).

FIG. 20(a) is a view showing a state in which a ring-shaped detection area, positive windows W_{P} and negative windows W_{N} are set on an optical image of the surface of a coin which is to be accepted.

FIG. 20(b) is a view showing a corresponding relationship between the histogram of the ring data D and the respective windows obtained from the optical image in FIG. 20(a).

FIG. 20(c) is a graph showing the difference data string ΔL for shifted amount of the ring data D obtained from the optical image in FIG. 20(a).

FIG. 20(d) is a view showing a corresponding relationship between the histogram and the respective windows when the ring data D is shifted by the rotation angle (60 degrees) at which the peak value of the difference data string ΔL in FIG. 20(c) is obtained.

FIG. 20(e) is a state in which characterizing portions are set on the optical image of the surface of a coin which is to be accepted.

FIG. 20(f) is a view showing a state in which the output data of detection portions corresponding to the characterizing portions are specified on the optical image of the surface of a coin which is to be accepted.

FIG. 21 is a view showing an example of an optical image in another pattern identification method in accordance with the first embodiment of the present invention.

FIG. 22 is a schematic flow chart showing identification steps in a conventional pattern identification method.

FIG. 23 is an explanatory view of processes schematically showing identification steps of a conventional pattern identification method.

### THE BEST MODE FOR CARRYING OUT THE INVENTION

The best modes for carrying out the present invention will be described below with reference to the accompanying drawings.

[Internal Structure of Identification Device]

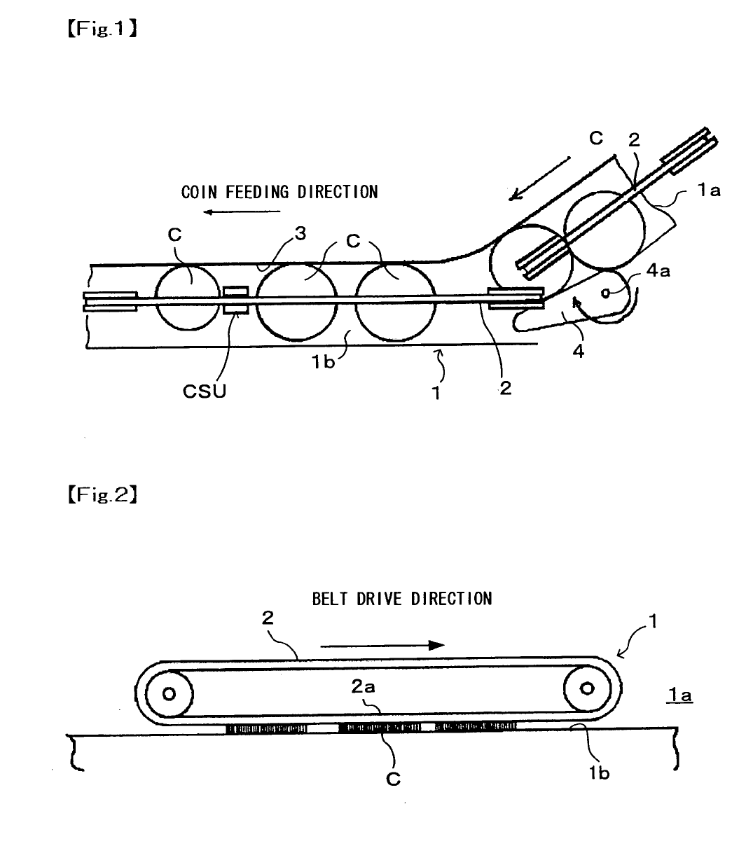

FIG. 1 is a plan view showing a schematic construction of a coin feeding path which is provided inside of an identification device in accordance with a first and a third embodiments of the present invention.

In FIG. 1, a bottom face sliding plate 1b is arranged for supporting a coin C as a circular object to be identified, which is carried toward the left side in the drawing from a feeding inlet part 1a on the right end side in the drawing, in a coin feeding path 1 formed so as to be bent at an angle of about 150 degrees in a plane view. Feeding belts 2 are arranged just above the bottom face sliding plate 1b.

A guide 3 is stood at one end part of the base sliding plate 1b so as to be arranged along the edge part of the bottom face sliding plate 1b. A coin controlling lever 4 for pressing the coin C on the guide 3b is turnably pivoted with a pin 4a at a curved portion of the coin feeding path 1. The coin controlling lever 4 is constructed so as to press the coin C, which is carried while supported on the bottom face sliding plate 1b, on the guide 3 by a biasing means such as a spring (not shown). The coins C carried toward the downstream side in the feeding direction from the position where the coin controlling lever 4 is disposed are successively carried while the outer peripheral face part is maintained to come in contact with the above mentioned guide 3.

An optical coin sensor device CSU for detecting a pattern formed on the surface of the coin C is installed in the coin feeding path 1. This optical coin sensor device CSU is provided with a CCD area sensor that is similar to, for example, the sensor disclosed in Japanese Patent Laid-Open No. Hei 5-143826.

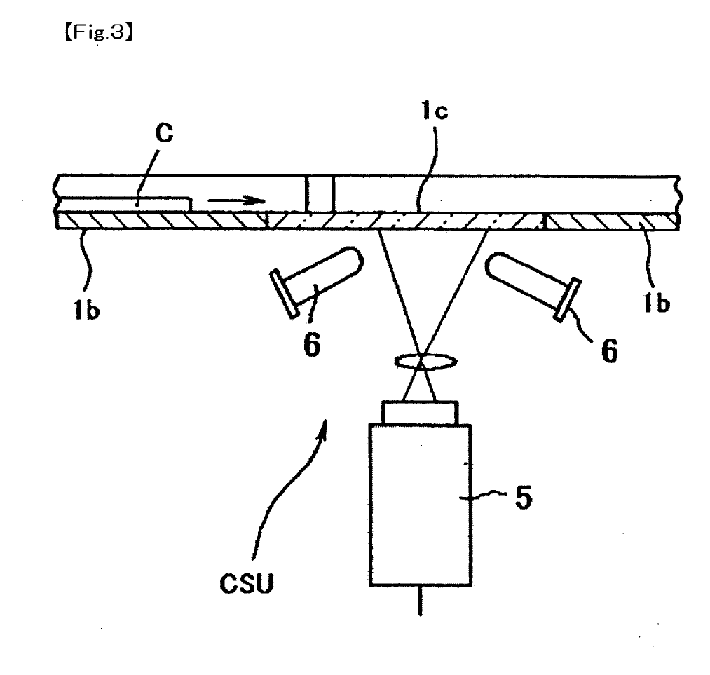

The feeding belt 2 and the optical coin sensor device CSU will be described in detail with reference to FIGS. 2 and 3. FIG. 2 is a side cross-sectional view showing the coin feeding path 1 which is provided inside of the identification device in accordance with the first and the third embodiments of the present invention. FIG. 3 is an enlarged side view showing a schematic construction of the optical coin sensor device CSU, which is provided inside of the identification device in accordance with the first embodiment of the present invention.

In FIG. 2, the feeding belt 2 is arranged such that a gap space corresponding to the thickness of the coin C is formed between the lower belt portion 2a and the bottom face sliding plate 1b in a roughly parallel and facing manner. The feeding belt 2 is constructed such that the coin C is carried toward the extending direction of the feeding belt 2 while the coin C is held between the feeding belt 2 and the bottom face sliding plate 1b.

Further, in FIG. 3, when the coin C carried along the bottom face sliding plate 1b reaches to a sensor position 1c, a sensor main body 5 provided inside with an image pickup element detects the coin C and illuminators 6 disposed so as to surround the sensor position 1c in a ring-shaped manner are turned on to take the reflected light from the coin C into the sensor main body 5. As a result, an optical image of a pattern formed on the surface of the coin C is obtained. The decision of denomination or genuineness is performed by using the optical image.

FIG. 4 is a plan view showing the schematic construction of a paper money feeding path which is provided inside of an identification device in accordance with a second embodiment of the present invention.

In FIG. 4, a paper money feeding path 20 on which a paper money is carried with a belt is provided with a paper money feeding mechanism 21 provided on the left end side in the drawing, an optical paper money sensor device CSU for detecting a pattern formed on the surface of the paper money, a paper money branching mechanism 23 for sorting the paper money in accordance with the kind of paper money, and a paper money accumulation mechanism 24 for accumulating the paper money in accordance with the kind of paper money.

The paper money feeding path 20 provided with such mechanisms operates in the same way as the above-mentioned coin feeding path 1. In other words, a paper money which is taken in by the paper money feeding mechanism 21 is carried inside (rightward in the drawing) by the paper money feeding path 20 and, when the paper money reaches to the position of the paper money sensor device CSU, an illuminator is turned on to take the reflected light from the paper money into the paper money sensor device CSU. As a result, the optical image of a pattern formed on the surface of the paper money is obtained and the decision of denomination or genuineness is performed by using the optical image. After the optical image is obtained, the paper money is classified into kinds by the paper money branching mechanism 23 and accumulated in the paper money accumulation mechanism 24.

[Electric Construction of Identification Device]

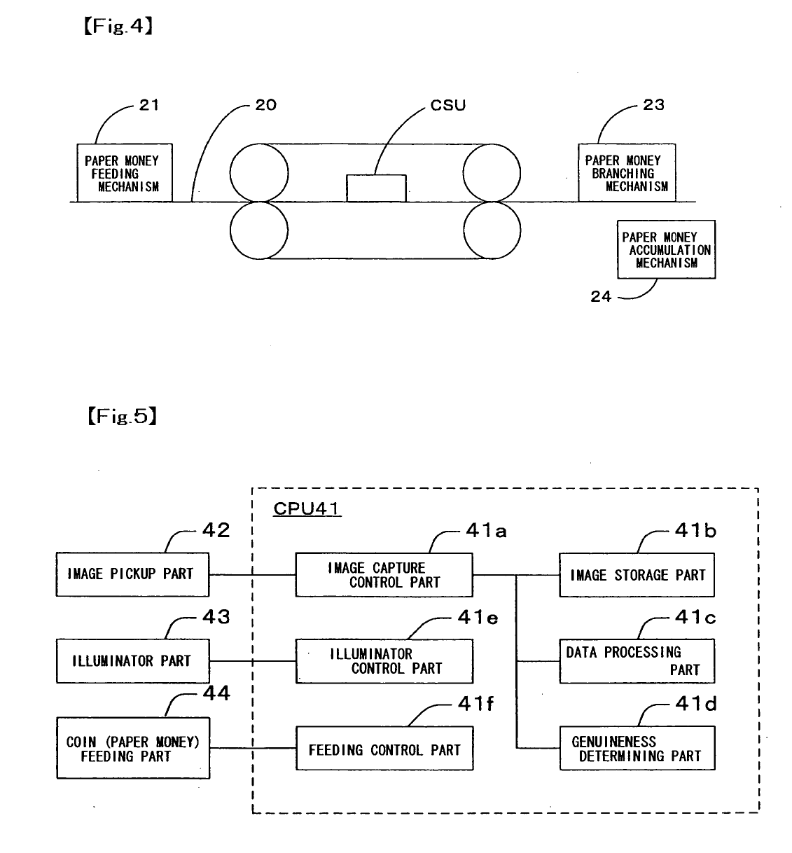

FIG. 5 is a block diagram showing an electric construction of the identification device in accordance with the first and the third embodiments of the present invention. The electric construction of the identification device (coin identification device) in accordance with the above-mentioned first and third embodiments is basically similar to the electric construction of the identification device (paper money identification device) in accordance with the above-mentioned second embodiment. Therefore, the electric construction of the identification device in accordance with the above-mentioned first and third embodiments will be described below.

In FIG. 5, the identification device in accordance with the first and the third embodiments of the present invention is provided with a central processing unit (hereinafter, abbreviated as CPU) 41, an image pickup part 42 for picking up the image of the coin C, an illuminator part 43 for illuminating the coin C, and a coin (paper money) feeding part 44 for carrying the coin C. The CPU 41 is provided with an image capture control part 41a for capturing image data from the image pickup part 42, an image storage part 41b for storing various image data including the image data captured by the image capture control part 41a, a data processing part 41c for processing image data stored in the image storage part 41b, and a genuineness determining part 41d for deciding the genuineness of the coin C on the basis of the processing result in the data processing part 41c. The CPU 41 is also provided with a illuminator control part 41e for controlling the illuminator part 43 and a feeding control part 41f for controlling the coin (paper money) feeding part 44.

In FIG. 5, the image storage part 41b is constructed by a primary cache (secondary cache) or the like in the CPU 41. However, it may be constructed by a storage means such as a DRAM or an SDRAM mounted outside of the CPU 41 as long as it has a function to store image data.

In the electric construction as described above, a pattern identification method in accordance with the first embodiment of the present invention, a pattern identification method in accordance with the second embodiment of the present invention and a pattern identification method in accordance with the third embodiment of the present invention will be described below.

[Pattern Identification Method in Accordance with First Embodiment]

FIG. 6 is a flow chart showing a pattern identification method in accordance with the first embodiment of the present invention. Here, a 100-yen coin is used as an example of a circular object (coin C).

In FIG. 6, first, optical image data of the coin C are captured (step S501). More concretely, the coin (paper money) feeding part 44 carries the coin C based on an instruction from the feeding control part 41f in the CPU 41. When the coin C is carried at a predetermined position, the illuminator part 43 illuminates the entire surface of the coin C based on an instruction from the illuminator control part 41e. When the reflected light from the surface of the coin C is inputted to the image pickup part 42 (for example, image sensor), the image capture control part 41a captures the optical image of the coin. C and the optical image is stored in the image storage part 41b. In general, such optical image is constructed of high-density images with each pixel having approximately 0.13 mm sq. on the X-Y coordinates and divided (multi-valued) by AD conversion such that the luminance (brightness) is 256 gradations. The optical image is stored in the image storage part 41b (for example, frame memory) as three-dimensional data with the luminance is on the Z-axis.

Next, the center point of the coin is detected (step S502). More concretely, the data processing part 41c reads out the optical image data stored in the image storage part 41b in the step S501. The optical image is projected in the X-axis direction and Y-axis direction to calculate the midpoint of the edges in the respective directions. As a result, the center coordinate of the coin C is obtained in which the midpoint of the edges in the X-axis direction is its X-coordinate and the midpoint of the edges in the Y-axis direction is its Y-coordinate.

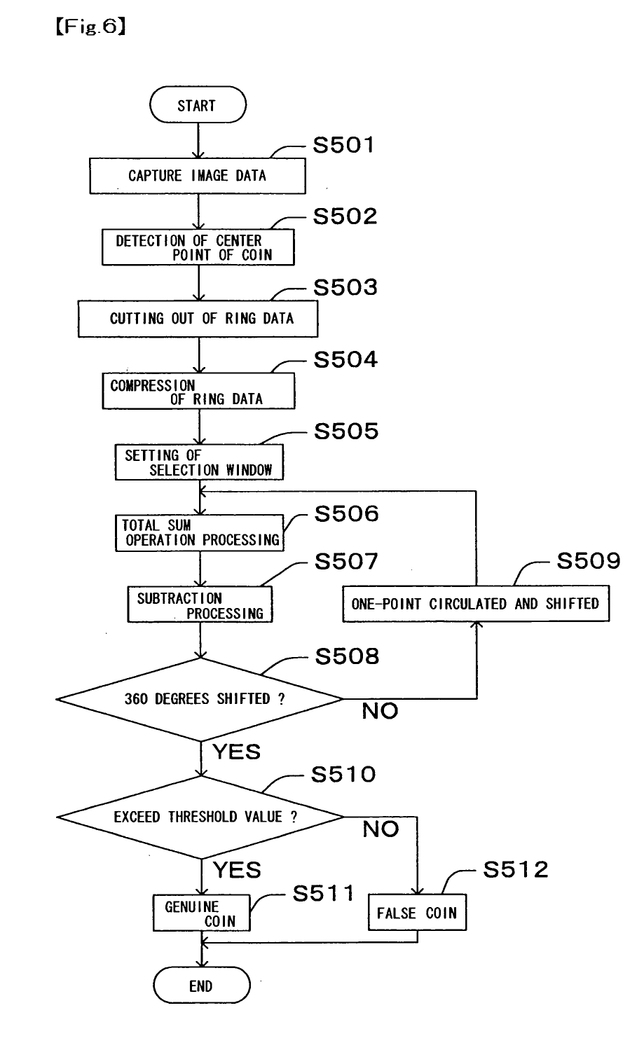

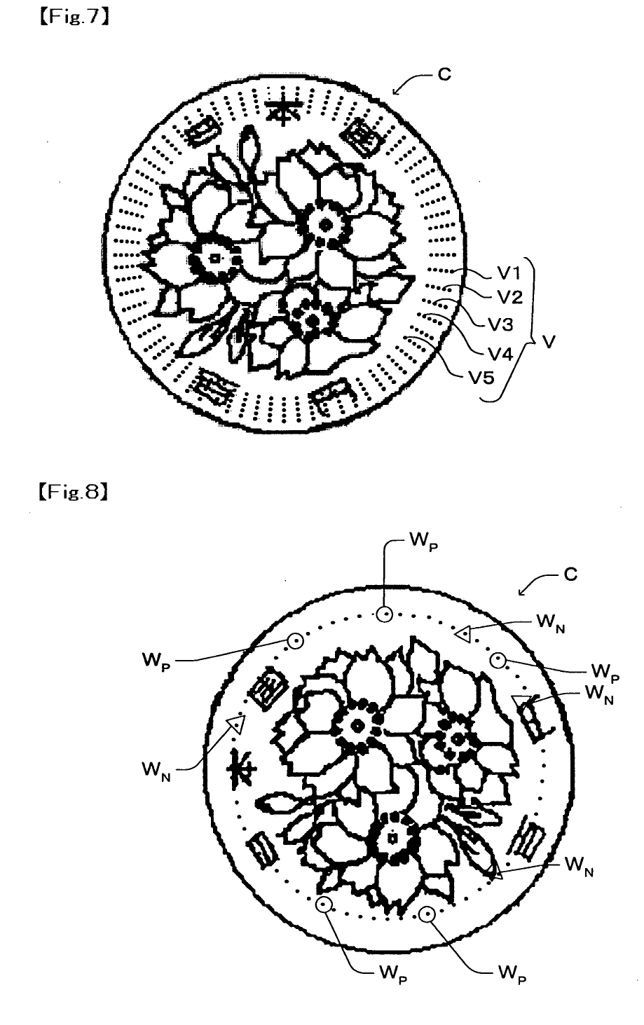

Next, the cutting out of ring data is performed (step S503). More concretely, first, the data processing part 41c sets a ring-shaped detection area V so as to include characteristic patterns of a 100-yen coin on the optical image of the coin C with the center coordinates of the coin C obtained in the step S502 as the reference (see FIG. 7). In the ring-shaped detection area V, five ring-shaped detection areas V₁, V₂, V₃, V₄, V₅ are set in a concentrically circular manner from the outer peripheral side of the coin C and prepared in advance according to the position of characteristic or uncharacteristic pattern of the coin C which is to be accepted. The data processing part 41c cuts out optical image data in a ring shaped manner with a prescribed angular pitch in the respective ring-shaped detection areas V₁, V₂, V₃, V₄, V₅. In FIG. 7, seventy-two detection points per each of the respective ring-shaped detection areas are cut out in a ring-shaped manner with an interval of angular pitch of 5 degrees to respectively create the ring data D₁ through D₅ as output data which are extracted and obtained with a prescribed pitch from the image data in the respective ring-shaped detection areas. The output data means not only the luminance data of the image but also the differential output image or twice differentiated image that are secondarily obtained by processing the luminance data.

In the pattern identification method in accordance with the first embodiment of the present invention, five pieces of ring data are created as shown in FIG. 7, but any cutting-out number of ring data may be used. An edge emphasizing processing is not performed when the ring data are cut out. However, the processing in the step S503 may include a processing which emphasizes the respective detection points by applying a differential processing with the use of spatial filter, for example, with 3×3 pixels.

Next, the compression of the ring data D₁ through D₅ is performed (step S504). More concretely, the data processing part 41c calculates the average value of data in the ring data D₁ through D₅ at respective cutting-out angles to obtain one-dimensional output data, i.e., the ring data D whose element is the calculated data. This processing provides an advantage such that, for example, even when stain adheres to only one specific spot of a 100-yen coin which causes to decrease the reflection factor of the spot, adverse effect due to the variation element (decreasing of reflection factor) does not affect so much in the ring data D. Normalization of level value may be performed as needed such that the dynamic range of the ring data D becomes uniform.

Next, the setting of selection windows is performed (step S505). More concretely, the data processing part 41c sets on the ring data D a selection window (hereinafter, abbreviated as positive window) W_{P} as a first selection area for extracting a range in which a local maximum value of the ring data D is included and a selection window (hereinafter, abbreviated as negative window) W_{N} as a second selection area for extracting a range in which a local minimum value of the ring data D is included. The setting patterns of the positive window W_{P} and the negative window W_{N} are previously stored in a memory such as a ROM depending on denomination and decided which setting pattern should be selected depending on denomination in the step of a temporary decision of denomination. For example, when the coin is estimated to be a 100-yen coin in the step of the temporary decision of denomination, a setting pattern is selected in which positive windows W_{P} are positioned on characteristic patterns of the 100-yen coin and negative windows WN are positioned at uncharacteristic portions of the 100-yen coin when the 100-yen coin is turned by an arbitrary angle. For example, when the 100-yen coin is turned by 90 degrees in the clockwise direction in FIG. 8, the characteristic amount of characteristic portions of the 100-yen coin (portions of [symbol] and [symbol] ) is extracted from the positive windows W_{P} and the characteristic amount of uncharacteristic portions of the 100-yen coin (flat portions except [symbol] and [symbol] ) is extracted from the negative windows WN. In FIG. 8, the shape of the positive window W_{P} is formed in a concentrically circular shape and the shape of the negative window W_{N} is formed in a triangular shape. However, the present invention is not particularly limited to these shapes and, for example, a window in an elliptical shape may be used. Also, a plurality of positive windows W_{P} and negative windows W_{N} are set but a single window may be used.

Next, total sum operation processing is performed (step S506). More concretely, the data processing part 41c calculates the total sum value S_{P} of the ring data D in the positive windows W_{P} set in the step S505 and the total sum value S_{N} of the ring data D in the negative windows W_{N} set in the step S505.

Next, subtraction processing is performed (step S507). More concretely, the data processing part 41c subtracts the total sum value S_{N} from the total sum value S_{P} which are calculated in the step S506. The value obtained by the subtraction processing is stored in the memory such as a RAM as a first element of the difference data string ΔL. When only the positive window W_{P} is used as the selection area and the negative window W_{N} is not used as the selection area, the processing of the step S 507 is not performed.

Next, it is judged whether or not the ring data D are shifted 360 degrees in the circumferential direction, in other words, for example, in FIG. 8, whether or not the ring data D and the positive windows W_{P} and the negative windows W_{N} are relatively circulated by every one point and seventy two times (step S508). More concretely, the data processing part 41c is provided with a previously initialized variable “i” (for example, “i”=1) and increments the variable “i” whenever one point is circulated, and judges whether or not the ring data D are shifted 360 degrees in the circumferential direction based on whether or not the variable “i” exceeds a predetermined value (“i”=72 in FIG. 8).

In the step S508, the positive windows W_{P} and the negative windows W_{N} are shifted 360 degrees in the circumferential direction so as to be shifted all over the circumference while being shifted by one pitch each in the circumferential direction. However, for example, when the positive windows W_{P} and the negative windows W_{N} are provided in a laterally symmetrical manner, the positive windows W_{P} and the negative windows W_{N} may be shifted 180 degrees so as to be shifted over a semicircle while being shifted by one pitch each in the circumferential direction. As a result, arithmetic quantity can be reduced and thus the speed of identification processing of a circular object can be increased.

In the step S508, when the data processing part 41c judges that the ring data D are not shifted 360 degrees in the circumferential direction, the ring data D and the positive windows W_{P}, the negative windows W_{N} are relatively circulated by one point each (step S509) and the processing is returned to the total sum operation processing in the step S506. The subtraction processing is performed by using the calculated result of the total sum operation processing (step S507) and the value obtained by the subtraction processing is stored in the memory such as a RAM as a subsequent element of the difference data string ΔL, and then the processing in the step S508 is performed again.

When the data processing part 41c judges that the ring data D are shifted 360 degrees in the circumferential direction in the step S508, identification processing whether or not a predetermined threshold value is exceeded is performed (step S510). In this identification processing, the peak value of the difference data string ΔL obtained by the above-mentioned processing is compared with a predetermined threshold value T. When the peak value is larger than the threshold value T, the information is transmitted to the genuineness determining part 41d and determined that it is a genuine coin (step S511). When the peak value is smaller than the threshold value T, the information is transmitted to the genuineness determining part 41d and determined that it is a false coin (step S512). Therefore, the genuineness of the coin C can be identified.

In the step S510, the peak value of the difference data string ΔL is used as an object to be compared with the threshold value T. The peak value of the difference data string ΔL is obtained when the characteristic pattern of a 100-yen coin is located within the positive windows W_{P} and the uncharacteristic portion of the 100-yen coin are located in the negative windows W_{N} in the case that the ring data D and the positive windows W_{P}, the negative windows W_{N} are relatively circulated by one point each. In other words, in FIG. 8, when the processing of the step S509 is repeated eighteen times (when the ring data D are shifted 90 degrees in the clockwise direction), the difference data string ΔL becomes the peak value. The peak value becomes relatively large based on the subtraction processing in the step S507 in comparison with values other than the peak value of the difference data string ΔL. Therefore, the extraction accuracy of the characteristic amount of a 100-yen coin can be simply and easily improved and stabilized at a low cost, and thus the discrimination performance can be improved.

Further, the identification processing is performed in the step S510 in which the peak value of the difference data string ΔL is compared with the predetermined threshold value T. The present invention is not limited to the above-mentioned processing. For example, an identification processing may be used in which the total number of the peak values of the difference data string ΔL is compared with a predetermined threshold value or an identification processing may be used in which the entire difference data string ΔL is compared with a reference difference data string which is set in advance. Such information of the peak values of the difference data string and the total number is stored in the memory such as a ROM in advance.

In FIG. 8, the above-mentioned peak value uses the maximum value of the difference data string ΔL but the minimum value of the difference data string ΔL may be used. In other words, in the pattern identification method in accordance with the first embodiment of the present invention, illumination with a small irradiation angle is used and thus the maximum value of the difference data string ΔL becomes the peak value because the brightness value becomes large in the pattern portion on the surface of the coin. On the contrary, when illumination with a large irradiation angle is used, the brightness value becomes large in the non-pattern portion on the surface of the coin and thus the minimum value of the difference data string ΔL becomes the peak value.

Further, in FIG. 6, the subtraction processing in the step S507 is performed just after the total sum operation processing in the step S506, but may be performed just before the identification processing in the step S510. According to the example described above, the respective elements of the data string comprised of the total sum value S_{N} are subtracted from the corresponding respective elements of the data string comprised of the total sum value S_{P}, and thus the entire difference data string ΔL is created at a time while, in the flow chart in FIG. 6, the difference data string ΔL is successively created by one element each.

Further, in the identification processing in the step S510 shown in FIG. 6, a value obtained by subtracting the average value of the brightness level (output level) of the difference data string ΔL from the peak value of the difference data string ΔL may be compared with a predetermined threshold value and the compared result is analyzed without comparing and analyzing the peak value of the difference data string ΔL with the predetermined threshold value. In this case, even when the reflection factor in the characteristic portion on the surface of the coin is totally lowered, for example, due to the aged deterioration of the surface of the coin owing to a longtime use, the same threshold value can be continuously used without changing the threshold value previously set. Accordingly, the extraction accuracy of the coin can be prevented from lowering due to the setting error based on the change of the set threshold value and thus the discrimination performance can be improved.

In addition, in the identification processing of the step S510 in FIG. 6, the peak value of the difference data string ΔL obtained by the processing in the steps S506 through S509 is compared with the predetermined threshold value T. However, a selection area which includes a local maximum value or a local minimum value of the difference data string ΔL may be furthermore set on the difference data string ΔL, and the peak value of the data string obtained by performing similar processing to the processing in the steps S506 through S509 may be compared with a predetermined threshold value T. According to the identification processing described above, the identification accuracy can be further improved.

For example, a subroutine shown in FIG. 9 is inserted between the processing in the step S508 shown in the flow chart of FIG. 6 and the processing in the step S510. First, the difference data string ΔL obtained by the processing in the step S508 in FIG. 6 is defined as specific input data, and a first specific selection area including a local maximum value of the specific input data and a second specific selection area including a local minimum value of the specific input data are set on the specific input data (step S201).

Next, a specific total sum operation processing is executed to obtain the first specific total sum value of the specific input data in the first specific selection area set by the step S201 and the second specific total sum value of the specific input data in the second specific selection area set by the step S201 (step S202).

Next, a subtraction processing is performed in which the second specific total sum value is subtracted from the first specific total sum value (step S203). The value obtained by the subtraction processing is stored in the memory such as a RAM as a first element of specific difference data string ΔL′.

Next, it is judged whether or not the difference data string ΔL and the specific selection areas have relatively shifted by the number of predetermined data points (step S204). In the step S204, when it is judged that the number of the predetermined data points has not shifted yet, the difference data string ΔL and the specific selection areas are relatively shifted by one data each (step S205) to return the processing to the specific total sum operation processing in the step S202. Then, the subtraction processing is performed by using the calculation result of the specific total sum operation processing (step S203), and the value obtained by the subtraction processing is stored in the memory such as a RAM as a next element of the specific difference data string ΔL′, and then the processing in the step S204 is performed again.

On the other hand, in the step S204, when it is judged that the number of the predetermined data points has shifted, it is decided whether or not the identification accuracy is sufficient (step S206). In the step S206, when it is judged that the identification accuracy is insufficient, the processing is returned to the step S201 to repeat a series of the above-mentioned processing again.

Finally, when it is judged that the identification accuracy is sufficient in the step S206, the processing is returned to the step S510 in FIG. 6. According to the processing described above, the identification accuracy can be further improved.

In FIG. 9, the subtraction processing is performed (step S203). However, when the total sum data string is used as the specific input data, the subtraction processing may be omitted. Further, at first the difference data string ΔL is used as the specific input data. However, the specific difference data string ΔL′ is employed after repeating processing (step S206) is performed.

### MODIFIED EMBODIMENT

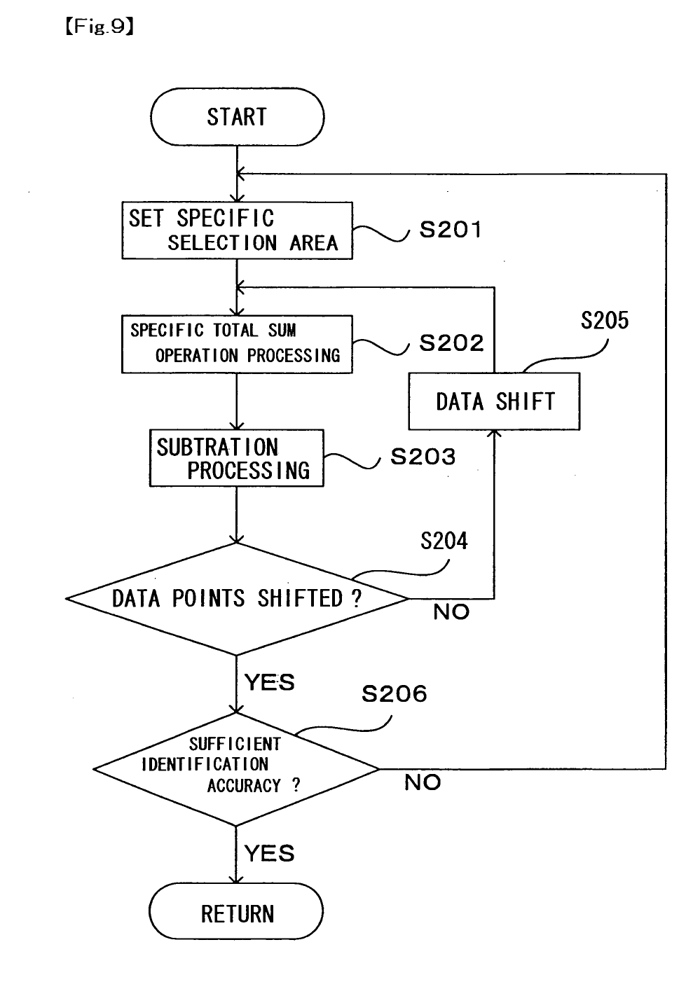

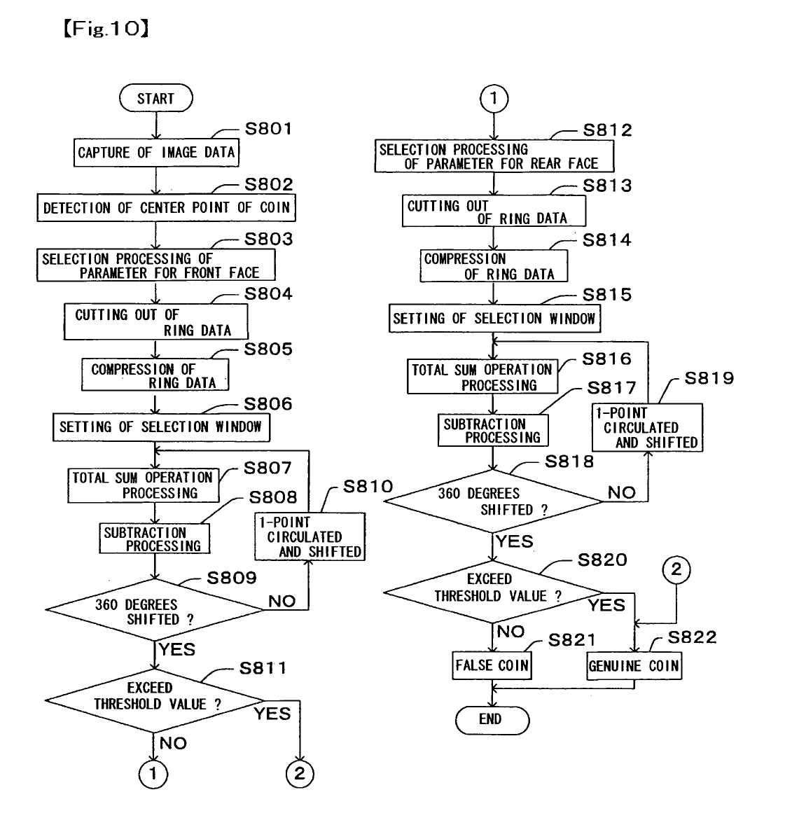

FIG. 10 is a flow chart showing another pattern identification method in accordance with the first embodiment of the present invention. According to this another pattern identification method, in the case that the spatial characteristics of the surfaces of a circular object to be accepted are different on the front face and the rear face, two kinds of parameter set for front face and rear face comprising a cut-out radius R of the ring data D, positive windows W_{P}, negative windows W_{N} and the threshold value T are prepared in advance. The genuineness of the circular object can be identified by using the two kinds of parameter set regardless of whether the picked-up optical image of the circular object is the front face or the rear face. This another identification method will be described below concretely.

In FIG. 10, first, optical image data are captured (step S801) and the center point of a coin is detected (step S802). The processing similar to the above-mentioned steps S501, S502 are performed and thus their descriptions are omitted.

Next, the selection processing of the parameter for front face is performed (step S803). More concretely, the data processing part 41c selects a cut-out radius R for front face, positive windows W_{P} for front face, negative windows W_{N} for front face and a deciding threshold value T for front face, which are previously stored in the memory such as a ROM, and sets them in the memory such as a RAM.

Next, respective processings are performed, which are the cutting out of ring data (step S804), the compression of the ring data (step S805), the setting of selection window (step S806), total sum operation processing (step S807), subtraction processing (step S808), and relatively circulated arithmetic operation of the ring data D and the positive windows W_{P}, the negative windows W_{N} (step S809 and step S810). These processings are similar to the processings in the above-mentioned steps S503 through S509 in FIG. 6, and thus their descriptions are omitted.

Next, when the data processing part 41c judges that the ring data D are shifted 360 degrees in the circumferential direction in the step S509, the data processing part 41c performs an identification processing of whether or not a threshold value is exceeded (step S811). This identification processing is performed such that the peak value of the difference data string ΔL obtained by the above described processing is compared with the threshold value T to determine a genuine coin when larger than the threshold value T (step S822). When the peak value is smaller than the threshold value T, it is judged that the coin is not a genuine coin or there is a possibility that the picked-up optical image is the rear face of the coin C. In the latter case, the processing in step S812 is performed.

In the step S811, when it is judged the threshold value T is not exceeded, the selection processing of the parameter for rear face is performed (step S812). More concretely, the data processing part 41c selects a cut-out radius R′ for rear face, positive windows W_{P}′ for rear face, negative windows W_{N}′ for rear face and a deciding threshold value T′ for rear face, which are previously stored in the memory such as a ROM, to set in the memory such as a RAM (overwriting on the parameter for front face).

Next, respective processings are performed, which are the cutting out of ring data (step S813), the compression of the ring data (step S814), the setting of selection window (step S815), total sum operation processing (step S816), subtraction processing (step S817), and relatively circulated arithmetic operation of the ring data D′ and the positive windows W_{P}′, the negative windows W_{N}′ (step S818 and step S819). These processings are similar to the processings in the above-mentioned steps S804 through S810 and thus their descriptions are omitted.

Next, when the data processing part 41c judges that the ring data D′ are shifted 360 degrees in the circumferential direction in the step S818, the data processing part 41c performs an identification processing whether a threshold value is exceeded or not (step S820). This identification processing is performed such that the peak value of the difference data string ΔL′ obtained by the above described processing is compared with the threshold value T′ to determine a genuine coin when larger than the threshold value T′ (step S822) and a false coin when smaller than the threshold value T′ (step S821). After the genuineness determining part 41d judges whether it is a genuine coin or a false coin finally, the subroutine is immediately finished.

As described above, according to another pattern identification method in accordance with the first embodiment of the present invention, the genuineness of a circular object is capable of being identified even when the spatial characteristics of the surface of a circular object to be accepted are different on the front face and the rear face.

### ANOTHER MODIFIED EMBODIMENT

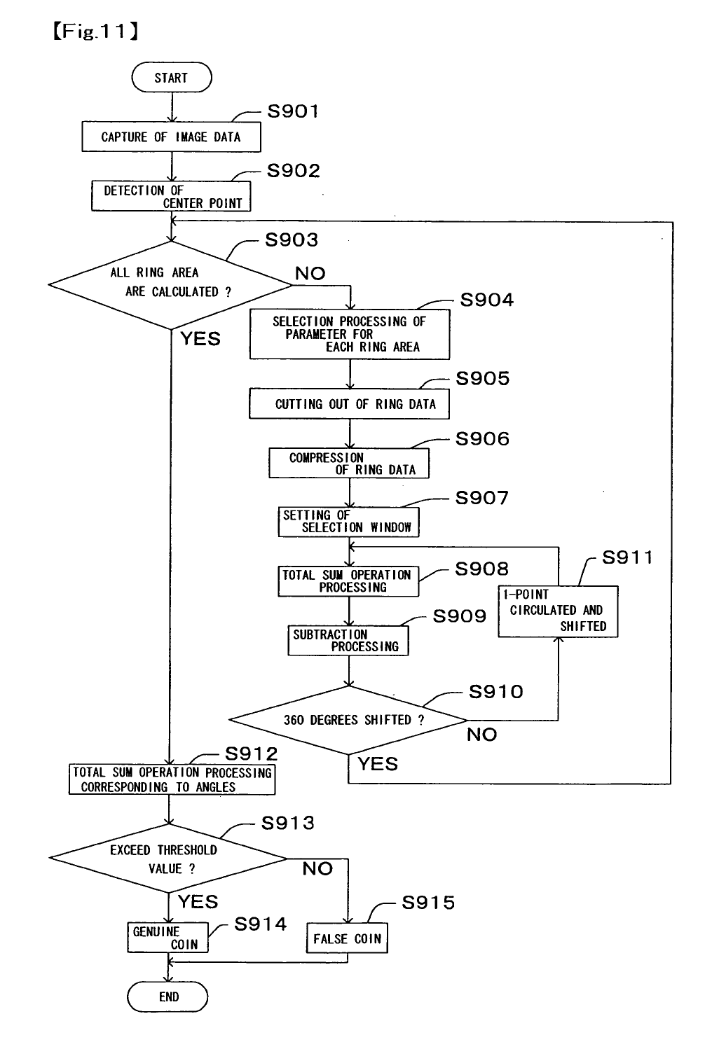

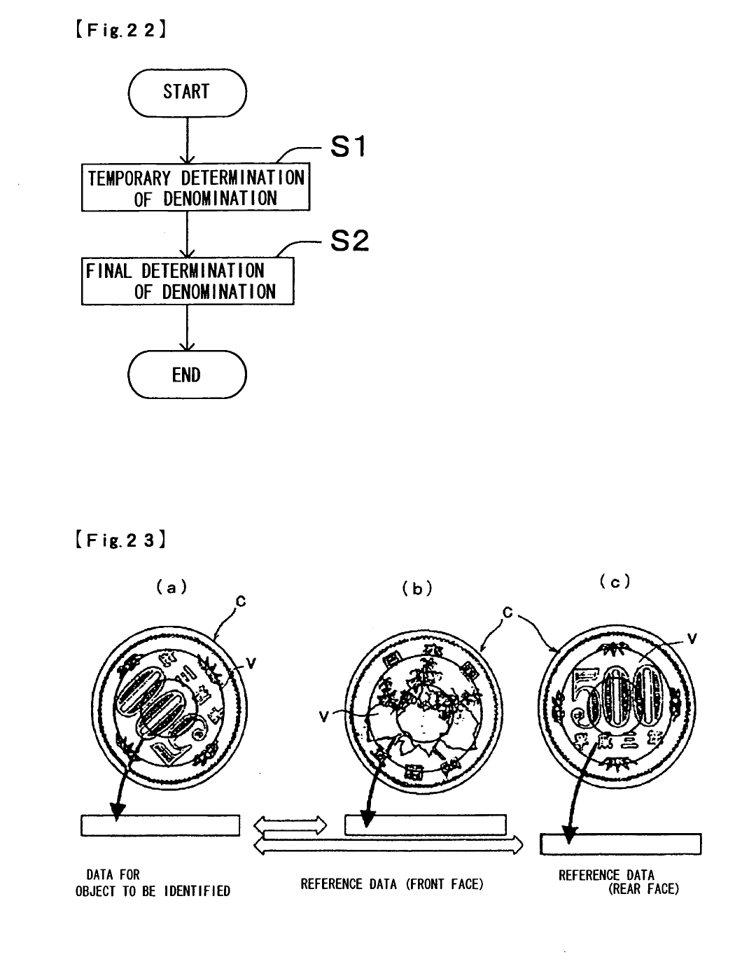

FIG. 11 is a flow chart showing another pattern identification method in accordance with the first embodiment of the present invention. In this another pattern identification method, ring data D are obtained from a plurality of places (a plurality of ring areas). A plurality of parameter sets comprising a cut-out radius R of ring data D, positive windows W_{P}, negative windows W_{N} and a threshold value T are prepared in advance. The total sum arithmetic operation of difference data string ΔL corresponding to each ring area is performed by using the above-mentioned parameter set and thus the spatial characteristic portion of the surface of the coin is further emphasized and the genuineness of a circular object can be identified with a high degree of accuracy. For example, as shown in FIG. 21, the ring data can be obtained from two ring areas comprising of a ring-shaped detection area V and a ring-shaped detection area V′. This another pattern identification method will be concretely described below.

In FIG. 11, first, the optical image data is captured (step S901). Next, the center point of the coin is detected (step S902). The processings are similar to those in the steps S501 and S502 and thus the description is omitted.

Next, it is judged whether or not the difference data string ΔL is calculated for all of a plurality of the ring areas (step S903). More concretely, the data processing part 41c uses a variable “k” (for example, k=1) which is previously initialized, increments one point the variable “k” whenever circulated, and judges whether or not the variable “k” exceeds the total number of predetermined ring areas.

When the data processing part 41c judges in the step S903 that the difference data string ΔL has not been calculated for all the ring areas yet, the selection processing of the parameter for each ring area is performed (step S904). More concretely, the data processing part 41c selects a cut-out radius R for each ring area, positive windows W_{P} for each ring area and negative windows W_{N} for each ring area, which are previously stored in the memory such as a ROM, and sets in the memory such as a RAM.

Next, respective processings are performed, which are the cutting out of ring data (step S905), the compression of the ring data (step S906), the setting of selection window (step S907), total sum operation processing (step S907), subtraction processing (step S909), and relatively circulated arithmetic operation of the ring data D and the positive windows W_{P}, the negative windows W_{N} (step S910 and step S911). These processings are similar to the processings in the above-mentioned steps S503 through S509 and thus their descriptions are omitted.

Next, when the data processing part 41c judges in the step S903 that the difference data string ΔL has been calculated for all the ring areas, the total sum operation processing corresponding to angles is performed (step S 912). More concretely, the data processing part 41c creates a difference total sum data string ΔSL in which the difference data string ΔL calculated in the step S908 through the step S911 on each ring area are added for each angle. The difference total sum data string ΔSL is added with all of a plurality of difference data string ΔL that has a peak value at a particular angle. Therefore, the peak value becomes an emphasized (larger) value in comparison with the individual peak value of each difference data string ΔL which is prior to performing the total sum arithmetic operation.

Finally, the dentification processing of the coin C is performed (step S913) after the above-mentioned total sum operation processing corresponding to angles in the step S912 is performed. More concretely, the data processing part 41c compares the peak value of the difference total sum data string ΔSL with a predetermined threshold value T. When the peak value is larger than the threshold value T, the information is transmitted to the genuineness determining part 41d to be determined that it is a genuine coin (step S914). When the peak value is smaller than the threshold value T, the information is transmitted to the genuineness determining part 41d to be determined that it is a false coin (step S915). Therefore, the genuineness of the coin C can be identified.

As described above, according to the another pattern identification method in accordance with the first embodiment of the present invention, the peak value of the difference total sum data string ΔSL obtained by the total sum operation processing corresponding to angles in the step S912 becomes further emphasized (larger) value in comparison with the individual peak value of each difference data string ΔL prior to performing the total sum arithmetic operation and thus the discrimination performance can be improved.

[Pattern Identification Method in Accordance with Second Embodiment]

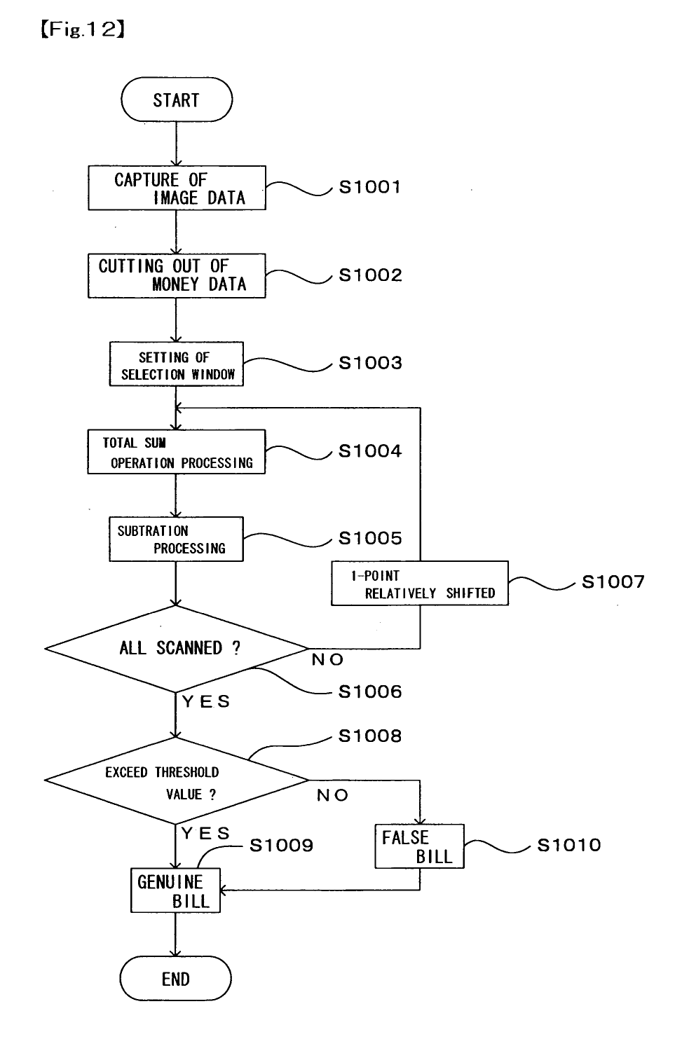

FIG. 12 is a flow chart showing a pattern identification method in accordance with the second embodiment of the present invention. In this embodiment, a 1000-yen bill is used as an example of a rectangular object (paper money).

In FIG. 12, first, optical image data of a paper money are captured (step S1001). More concretely, the coin (paper money) feeding part 44 (paper money feeding mechanism 21) carries the paper money based on an instruction from the feeding control part 41f in the CPU 41. When the paper money is carried at a predetermined position, the illuminator part 43 illuminates the entire surface of the paper money based on an instruction from the illuminator control part 41e. When the reflected light from the surface of the paper money is inputted to the image pickup part 42 (for example, image sensor), the image capture control part 41a captures the optical image of the paper money and the optical image is stored in the image storage part 41b.

Next, the cutting out of money data is performed (step S1002). More concretely, the data processing part 41c cuts out optical image data with a prescribed pitch (for example, every one pixel) in a rectangular shape at a right corner including the characteristic pattern of the 1000-yen bill on the optical image of the paper money (see FIG. 13).

Next, the setting of selection window is performed (step S1003). More concretely, the data processing part 41c sets on the money data cut out by the processing in the step S1002 selection windows (positive window) W_{P} as a first selection area for extracting a range in which a local maximum value is included and selection windows (negative window) W_{N} as a second selection area for extracting a range in which a local minimum value is included. The setting patterns of the positive windows W_{P} and the negative windows W_{N} are previously stored in a memory such as a ROM, and it is decided which setting pattern should be selected in the step of a temporary decision of denomination. For example, when the paper money is estimated to be a 1000-yen bill in the step of the temporary decision of denomination, a setting pattern is selected in which positive windows W_{P} are positioned on characteristic patterns of the one-thousand-yen bill and negative windows W_{N} are positioned on uncharacteristic portions of the 1000-yen bill when the positive windows W_{P} and the negative windows W_{N} are relatively moved to the 1000-yen bill.

For example, in FIG. 14(a), when a selection area is set in which positive windows W_{P} and negative windows W_{N} are alternately set at a roughly center of an 1000-yen bill, the characteristic amount of the characteristic portions of the 1000-yen bill (numeral portion of “1000” (dark portion of dark/bright pattern)) can be extracted from the positive windows W_{P} and the characteristic amount of the uncharacteristic portions of the 1000-yen bill (portion except the numeral “1000” (bright portion of dark/bright pattern)) can be extracted from the negative windows WN. In other words, the output of level value when the selection area, in which the positive windows W_{P} and the negative windows W_{N} are alternately set, is located at the position shown in FIG. 14(a) is illustrated in the waveform as shown in FIG. 14(b). Therefore, it is understood that the output of characteristic amount (level value) extracted from the positive windows W_{P} is higher than the output of characteristic amount (level value) extracted from the negative windows WN.

In FIGS. 14(a) and 14(b), high density portions are selected as the object for adding. In FIG. 14(a), the positive window W_{P} is set in a square shape and the negative window W_{N} is also set in a square shape. However, the present invention is not limited to the above-mentioned shape and may use a window, for example, formed in a shape such as a circle, an ellipse and a trapezoid. Further, a plurality of positive windows W_{P} and a plurality of negative windows W_{N} are set in the above-mentioned embodiment but a single positive window W_{P} and a single negative window W_{N} may be respectively utilized.

Next, the total sum operation processing is performed (step S1004). More concretely, the data processing part 41c calculates the total sum value S_{P} of the money data in the positive windows W_{P} set in the step S1003 and the total sum value S_{N} of the money data in the negative windows W_{N} set in the step S1003.

Next, the subtraction processing is performed (step S1005). More concretely, the data processing part 41c subtracts the total sum value S_{N} from the total sum value S_{P} calculated in the step S1004. The value obtained by the subtraction processing is stored in the memory such as a RAM as the first element of the difference data string ΔL. When only the positive window W_{P} is used as the selection area and the negative window W_{N} is not used as the selection area, the processing of the step S507 is not performed. In this case, the total sum value S_{P} itself which is calculated in the step S1004 is stored in the memory such as a RAM as the first element of the total sum data string.

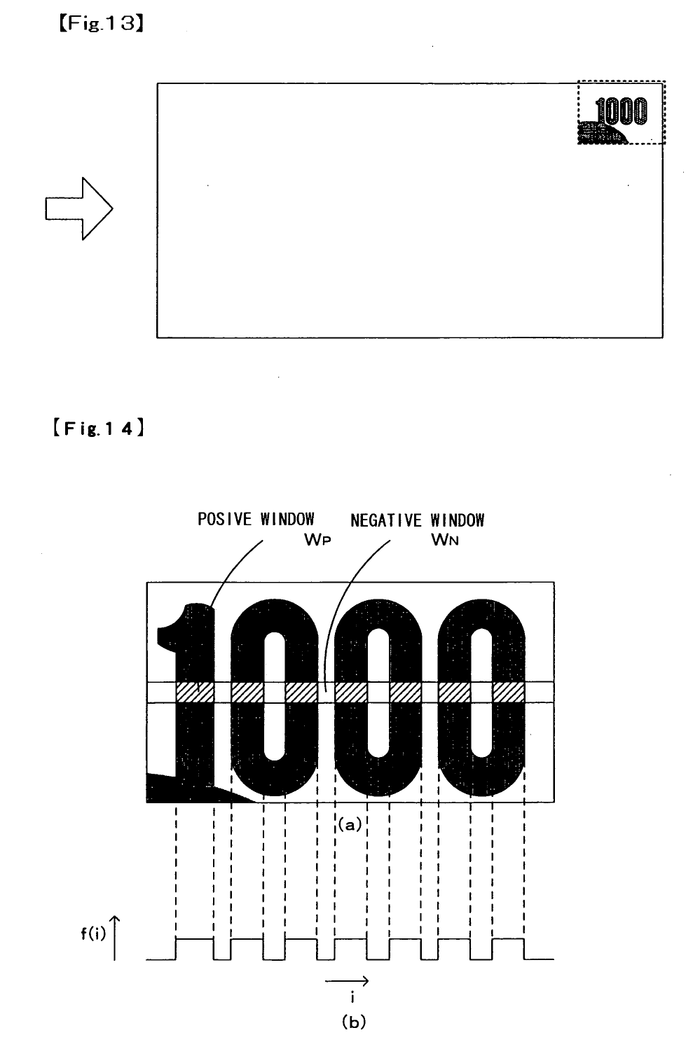

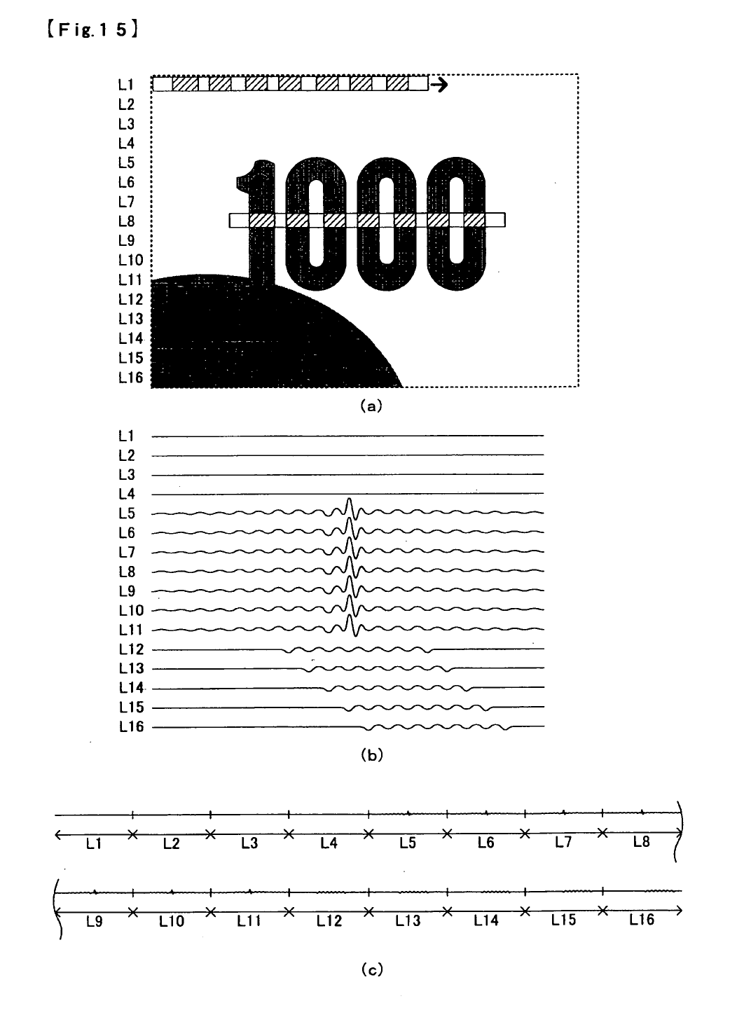

Next, it is judged whether or not all the money data are scanned, in other words, for example, in FIG. 15(a), it is judged whether or not all the money data are scanned in the longitudinal and the transverse directions such that the money data and the positive windows W_{P}, the negative windows W_{N} are relatively shifted by every one point (one pixel) (step S1006). More concretely, in the data processing part 41c, previously initialized variables “i”, “j” (for example, “i”, “j”=1) are used and the variable “i” is incremented whenever one point is shifted rightward from the left end of the level one “L1” (money data of the uppermost level). When the variable “i” exceeds a predetermined value (point number in the transverse direction in FIG. 15(a)), the variable “j” is incremented (“j”=2) and the variable “i” is initialized (“i”=1) to shift to the level two “L2” (money data in the second level from above). It is judged whether or not all the money data are scanned based on whether or not the variable “j” exceeds a predetermined value (“j”=16 in FIG. 15(a)).

In the step S1006, when the data processing part 41c judges that all the money data have not been scanned yet, the money data and the positive windows W _{P}, the negative windows W_{N} are relatively shifted rightward (or lower) by one point each (step S1007). After that, the processing is returned to the total sum operation processing in the step S1004, and the subtraction processing is performed by using the calculation result of the total sum operation processing (step S1005). The value obtained by the subtraction processing is stored in the memory such as a RAM as a subsequent element of the difference data string ΔL and then the processing in the step S1006 is performed again.

In the embodiment of the present invention, the money data are formed in a two-dimensional matrix. Therefore, the difference data obtained by the subtraction processing in the step S1005 (or the total sum value S_{P} calculated in the step S1004 in the case that the subtraction processing in the step S1005 is not performed) are also formed in a two-dimensional matrix. In other words, as shown in FIG. 15(b), for example, when the horizontal axis is a relatively shifted amount (point number) and the vertical axis is the difference data obtained by the subtraction processing in the step S1005, the difference data are generally small and there is little change in density in the “L1”, and thus a flat waveform is obtained. Similarly, in the “L2” through “L4”, there are little change in density and thus flat waveforms are obtained. However, in the “L5” through “L11”, the outstanding peak value is obtained at the timing that the characteristic amount of the characteristic portion of a 1000-yen bill (numeral portion of “1000”) is extracted from the positive windows W_{P} and the characteristic amount of the uncharacteristic portion of the 1000-yen bill (flat portion except the numerals of “1000”) is extracted from the negative windows WN. When relatively shifted from this point in the right or left direction, waveforms are obtained in which local minimum values and local maximum values are alternately represented. The above-mentioned difference data string ΔL can be obtained by successively combining the waveforms in the respective levels of the “L1” through “L16” (one-dimensional difference data) (see FIG. 15(c)) and constructed of the waveforms of 16 sections which are comprised of the “L1” through “L16”.

On the other hand, when the data processing part 41c judges in the step S1006 that all the money data have been scanned, the data processing part 41c performs an identification processing of whether or not a prescribed threshold value is exceeded (step S1008). In this identification processing, the peak value of the difference data string ΔL which is obtained by the above mentioned processing is compared with the predetermined threshold value “T” and, when the peak value is larger than the threshold value “T”, it is judged to be a genuine bill (step S1009) and when the peak value is smaller than the threshold value “T”, it is judged to be a false bill (step S1010). Accordingly, the genuineness of paper money can be identified.

In the step S1008, the peak value of the difference data string ΔL is used as an object to be compared with the threshold value T. The peak value of the difference data string ΔL is the value when the characteristic pattern of a 1000-yen bill is located in the positive windows W_{P} and the uncharacteristic portion of the 1000-yen bill is located in the negative windows W_{N} in the case that the money data and the positive windows W_{P}, the negative windows W_{N} are relatively shifted by one point each. In other words, in FIG. 15(c), the difference data string ΔL exhibits a plurality of peak values in the vicinity of the center of the respective sections of “L5” through “L11”. Therefore, the extraction accuracy of the characteristic amount of the 1000-yen bill can be easily improved and stabilized at a low cost and, as a result, the discrimination performance is enhanced.

In the second embodiment of the present invention, the selection area in which the positive windows W_{P} and the negative windows W_{N} are alternately set is formed in a line in the horizontal direction and the total sum operation processing is performed while the selection area is relatively shifted in the horizontal direction. However, the present invention is not limited to the above-mentioned embodiment. The selection area in which the positive windows W_{P} and the negative windows W _{N} are alternately set may be formed in a line in the vertical direction and the total sum operation processing may be performed while the selection area is relatively shifted in the vertical direction. Alternatively, the selection area in which the positive windows W_{P} and the negative windows W_{N} are alternately set may be formed in a two-dimensional plane and the total sum operation processing may be performed while the selection area is relatively shifted in the horizontal or the vertical direction.

Further, in the second embodiment of the present invention, the optical image data captured in the above-mentioned step S1001 are used as intact. However, filtering processing by using a differential, smoothing filter or the like may be performed if necessary.

In addition, as described in the first embodiment of the present invention, the second embodiment of the present invention may be also applied to various examples. For example, the minimum value of the difference data string ΔL may be adopted as the peak value instead of using the maximum value. The subtraction processing in the step S1005 may be performed just before the identification processing in the step 1008. Alternatively, the value which is subtracted the average value of the brightness level (output level) of the difference data string ΔL from the peak value of the difference data string ΔL may be compared and analyzed with the predetermined threshold value.

In addition, the matter (performing the identification processing for both the front face and the rear face of a paper money) described in the modified embodiment in accordance with the first embodiment of the present invention can be also applied to the second embodiment of the present invention. Also, the matter (the money data are extracted from a plurality of portions on the surface of a paper money instead of using a portion to perform the identification processing) described in the another modified embodiment in accordance with the first embodiment of the present invention can be also applied to the second embodiment of the present invention. Furthermore, different from a circular object in which the position of its characteristic portions or uncharacteristic portions may change in the circumferential direction at the time of feeding, the position of its characteristic portions or uncharacteristic portions does not change during feeding in a rectangular object such as a paper money. Therefore, the genuineness of a paper money can be identified by obtaining the total sum value S_{P} or the total sum value S_{N} under the state that the positive windows W_{P} or the negative windows W_{N} are fixed. In this case, for example, the genuineness can be identified by comparing the total sum value S_{P} or the total sum value S_{N} with a predetermined threshold value and analyzing the result. Alternatively, the genuineness may be identified by comparing the value of the difference between the total sum value S_{P} and the total sum value S_{N} with a predetermined threshold value and analyzing the result.

[Pattern Identification Method in Accordance with Third Embodiment]

FIG. 16 is a flow chart showing a pattern identification method in accordance with a third embodiment of the present invention. In this embodiment, a 100-yen coin is used as an example of a circular object (coin C).

In FIG. 16, the flow from the step S601 through the step S608 is similar to the flow from the step S501 through the step S508 in FIG. 6 in the above-mentioned first embodiment, and thus their descriptions are omitted and the flow after the step S610 will be described.

When the data processing part 41c judges that the ring data D have been shifted 360 degrees in the circumferential direction in the step S608, the detection of the peak value is performed (step S610). More concretely, the data processing part 41c stores the peak value of the difference data string ΔL obtained by the above mentioned processing in the memory such as a RAM.

Then, the peak value is detected (step S610) and the detection of the rotation angle is performed (step S611). More concretely, the data processing part 41c detects the rotation angle by calculating the shift amount corresponding to the peak value of the difference data string ΔL. For example, in FIG. 8, the peak value of the difference data string ΔL is obtained when the characteristic patterns of a 100-yen coin are located within the positive windows W_{P} and the uncharacteristic portions of the 100-yen coin are located in the negative windows W_{N} in the case that the ring data D and the positive windows W_{P}, the negative windows W_{N} are relatively circulated by one point each. Therefore, the peak value is obtained when the processing of the step S609 is repeated 18 times (when the ring data D are shifted 90 degrees in the clockwise direction), in other words, when the coin C is rotated by 90 degrees. Accordingly, the rotation angle θ (90 degrees in FIG. 8) of the coin C corresponding to the peak value can be detected by detecting the peak value of the difference data string ΔL.

In FIG. 16, the subtraction processing in the step S607 is performed just after the total sum operation processing in the step S606 but may be performed just before the identification processing in the step S610. According to the above-mentioned embodiment, the respective elements of the data string comprising of the total sum value S_{N} are subtracted from the respective corresponding elements of the data string comprising of the total sum value S_{P}. Therefore, in the flow chart in FIG. 16, the difference data string ΔL is successively created by one element each but, in this embodiment, all the difference data string ΔL is created at a time.

Next, the processing for specifying characteristic portions is performed (step S612). More concretely, the data processing part 41c uses the parameters (radius distance “r” from the center position O of the coin C and the rotation angle θ₀) showing the characteristic portions peculiar to the coin C, which are previously set, and the rotation angle θ detected in the step S611 to specify the output data (brightness data) of the detected section corresponding to the characteristic portions peculiar to the coin C on the optical image captured by the processing in the step S601.

For example, in FIG. 17, the characteristic portions peculiar to the coin C is composed of a first characteristic portion P_{P} (stigma portion of a flower) including a characteristic pattern of the coin C and a second characteristic portion P_{N} (petal portion) which is not provided with a characteristic pattern of the coin C. The first characteristic portion P_{P} is set by using a polar coordinate system having two parameters, that is, the radius distance “r_{P}” representing the distance from the center position (C_{X}, C_{Y}) of the coin C obtained in the step S602 and the rotation angle θ_{0P} representing the angle from the position without rotation (position at twelve of a clock) of the coin C. The second characteristic portion P_{N} is set by using a polar coordinate system having two parameters, that is, the radius distance “r N” representing the distance from the center position (C x, C y) of the coin C and the rotation angle θ_{0N} representing the angle from the position without rotation (position at twelve of the clock) of the coin C. When the optical image of the coin C actually obtained in the step S601 is the image as shown in FIG. 18, the X-coordinate P_{PX}, the Y-coordinate P _{PY} of the output data for the detected section corresponding to the first characteristic portion P_{P} and the X-coordinate P_{NX}, the Y-coordinate P_{NY} of the output data for the detected section corresponding to the second characteristic portion P_{N} are respectively specified in the following expression by using the rotation angle θ detected in the step S612.

[Equation 2]
P_{PX}=C_{X}+r_{P}×sin(θ+θ_{0P})
P_{PY}=C_{Y}+r_{P}×cos(θ+θ_{0P})
P_{NX}=C_{X}+r_{N}×sin(θ+θ_{0N})
P_{NY}=C_{Y}+r_{N}×cos(θ+θ_{0N})

Here, the center position of the coin C is obtained in the step S602. Also, in FIGS. 17 and 18, the first characteristic portion P_{P} and the second characteristic portion P_{N} are respectively set at one position each for convenience of description. However, it is preferable to respectively set a plurality of positions from the viewpoint to further improve the discrimination performance.

In relation to setting the characteristic portion at a plurality of positions, when the characteristic portion is formed in a straight line shape, two coordinates at both end points of the straight line are prepared (set). In this case, the output data in the detected sections corresponding to the two positions are specified by using the rotation angle θ detected in the step S611, and the output data on the straight line connected with these two positions can be specified. Further, when characteristic portions are gathered in an area, the coordinate of its center point is prepared (set). In this case, the output data in the detected sections corresponding to the position of the center point are specified by using the rotation angle θ detected in the step S611, and the output data near the center point (for example, 5×5=25) can be specified. In addition, when the characteristic portion is formed in an annular shape, the coordinate of the center point of a ring and the radius distance “r′” of the ring are prepared (set). In this case, the output data in the detected section corresponding to the position of the center point of the ring are specified by using the rotation angle θ detected in the step S611, and the output data separated from the position of the output data by the radius distance “r′” can be specified.

As described above, when the characteristic portion is formed in a prescribed shape, a required minimum number of parameters capable of realizing the shape is prepared without previously preparing all the parameters for the plurality of characteristic portions and the output data of the detected section obtained so as to correspond to the characteristic portion can be specified only by the parameters and the rotation angle θ detected in the step S611. Thereby, the data amount which is previously stored can be reduced and thus the identification processing can be realized at a high speed and a low cost.

In order to specify the output data in the detected section corresponding to the characteristic portion peculiar to the coin C, the detecting deviation of the characteristic portions P_{P}, P_{N} of the coin C can be amended while the radius distance “r” or the rotation angle θ₀ or the rotation angle θ of the coin C is slightly changed. In other words, for example, the processing for extracting the output data specified by the radius distance “r”, the rotation angle θ₀ and the rotation angle θ is repeated while shifting the center position O of the coin C by several pixels in the X-axis direction or the Y-axis direction. Then, the maximum value or the minimum value of the extracted output data is specified as the output data for the detected section corresponding to the characteristic portion peculiar to the coin C and, as a result, the detecting deviation of the characteristic portions P_{P}, P_{N} of the coin C can be amended. Further, for example, the detecting deviation of the characteristic portions P_{P}, P_{N} of the coin C can be amended by performing similar processing while the rotation angle θ is shifted by several degrees.

Next, the addition processing is performed (step S613). More concretely, when a plurality of output data for detecting sections corresponding to the first characteristic portion P_{P} specified in the step S612 are set, the data processing part 41c adds all the plurality of output data to obtain the total sum value P_{PS} of the output data for the detecting section corresponding to the first characteristic portion P_{P}. Also, when a plurality of second characteristic portions P_{N} specified in the step S612 are set, the data processing part 41c adds all output data for the detecting sections corresponding to the plurality of characteristic portions P_{N} to obtain the total sum value P_{NS} of the output data for the detecting sections corresponding to the second characteristic portions P_{N}. When the output data in the detecting section corresponding to the first characteristic portion P_{P} specified in the step S612 is set to be single, the output data itself are used as the total sum value P_{PS} and, when the output data in the detecting section corresponding to the second characteristic portion P_{N} specified in the step S612 is set to be single, the output data itself is used as the total sum value P_{NS}.

Next, the peak value of the difference data string ΔL obtained in the above-mentioned step S610 is added to the value which is subtracted the above-mentioned total sum value P_{NS} from the above-mentioned total sum value P_{PS}. Then, the identification processing is performed (step S614) in which whether or not the value obtained by adding exceeds a predetermined threshold value T. As a result, when the value is larger than the threshold value T, it is judged to be a genuine coin (step S615) or, when it is smaller than the threshold value T, it is judged to be a false coin (step S616). Consequently, the genuineness of the coin C can be accurately identified.

In the step S614, the peak value of the difference data string ΔL is used as a part of the object to be compared with the threshold value T. The peak value of the difference data string ΔL is obtained when the characteristic patterns of a 100-yen coin are located within the positive windows W_{P} and the uncharacteristic portions of the 100-yen coin are located in the negative windows W_{N} in the case that the ring data D and the positive windows W_{P}, the negative windows W_{N} are relatively circulated by one point each. In other words, in FIG. 8, the difference data string ΔL exhibits the peak value when the processing of the step S609 is repeated 18 times (when the ring data D are shifted 90 degrees in the clockwise direction). The peak value becomes relatively large in comparison with the values expect the peak value of the difference data string ΔL due to the subtraction processing in the step S607.

In addition, in the step S614, the value subtracted the total sum value P_{PN} from the total sum value P_{PS} is used as a part of the object to be compared with the threshold value T. The value subtracted the total sum value P_{PN} from the total sum value P_{PS} becomes a large value when the Coin C is a genuine coin but becomes a small value when the coin C is a false coin. This is because that the first characteristic portions P_{P} are set in the positions of the characteristic pattern of the coin C and the second characteristic portions P_{N} are set in the positions where the characteristic pattern of the coin C is not present. Therefore, the discrimination performance can be further enhanced in comparison with the method in which only the peak value of the difference data string ΔL is compared with a predetermined threshold value.

In FIG. 8, the above mentioned peak value employs the maximum value of the difference data string ΔL but the minimum value of the difference data string ΔL may be employed as described above. In other words, in the pattern identification method in accordance with the third embodiment of the present invention, the illumination with a small irradiation angle is used such that the brightness value becomes large in the pattern portion of the surface of the coin and thus the maximum value of the difference data string ΔL becomes the peak value. On the contrary, when the illumination with a large irradiation angle is used, the brightness value becomes large in the non-pattern portion of the surface of the coin and thus the minimum value of the difference data string ΔL becomes the peak value. In this case, the peak value of the difference data string ΔL obtained in the above-mentioned step S610 is subtracted by the value which is subtracted the above-mentioned total sum value P_{NS} from the above-mentioned total sum value P_{PS}. Then, the processing in the step S614 is performed in which whether or not the value obtained by the above-mentioned subtraction becomes to be equal to or less than a predetermined threshold value T.

Further, the genuineness of the coin C can be identified by comparing the value, which is subtracted the above mentioned total sum value P_{NS} from the above mentioned total sum value P_{PS}, with a predetermined threshold value, or by comparing the above mentioned total sum value P_{PS} itself or the above mentioned total sum value P_{NS} itself with a predetermined threshold value. According to the method described above, the load of arithmetic processing in the data processing part 41c can be reduced and, as a result, the time period for identification of the genuineness of the coin C can be shortened.

### EXAMPLES

Examples of the present invention will be described in detail below by using the data obtained in the experiments. Example 1 is described in detail by using the data obtained by the experiment in the identification device in accordance with the first embodiment of the present invention. Example 2 is described in detail by using the data obtained by the experiment in the identification device in accordance with the third embodiment of the present invention.

### First Example

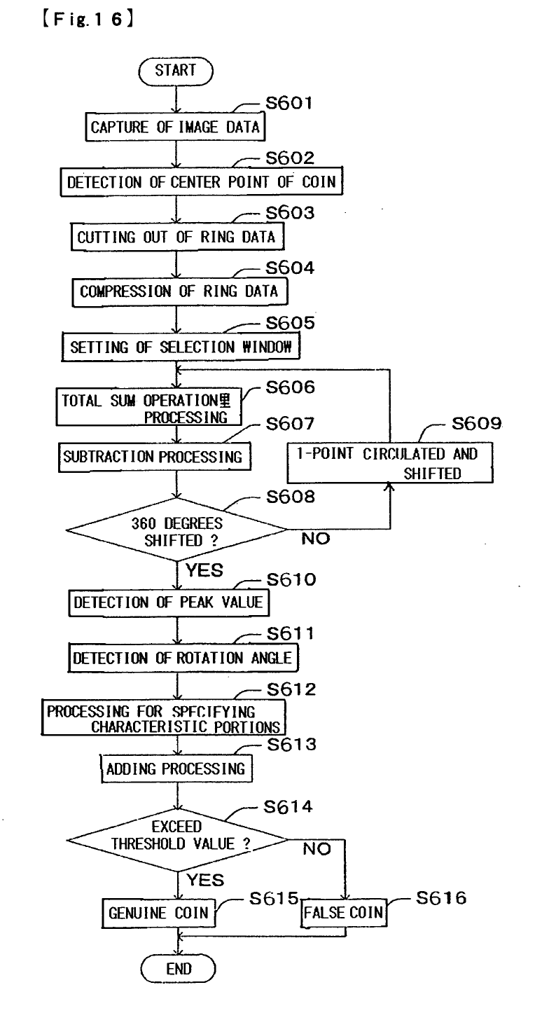

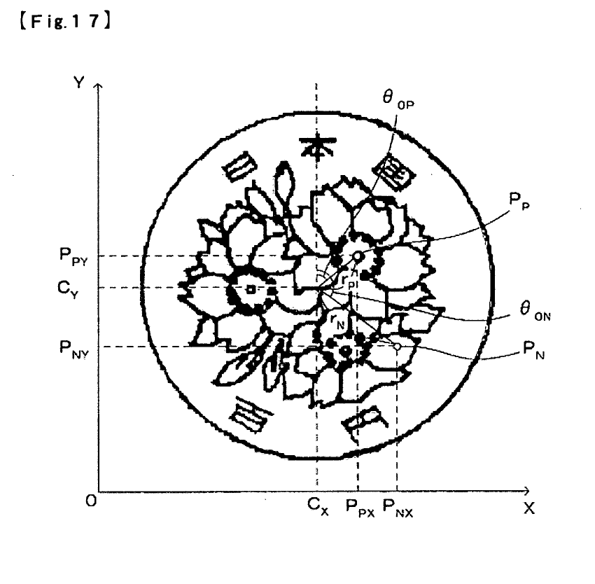

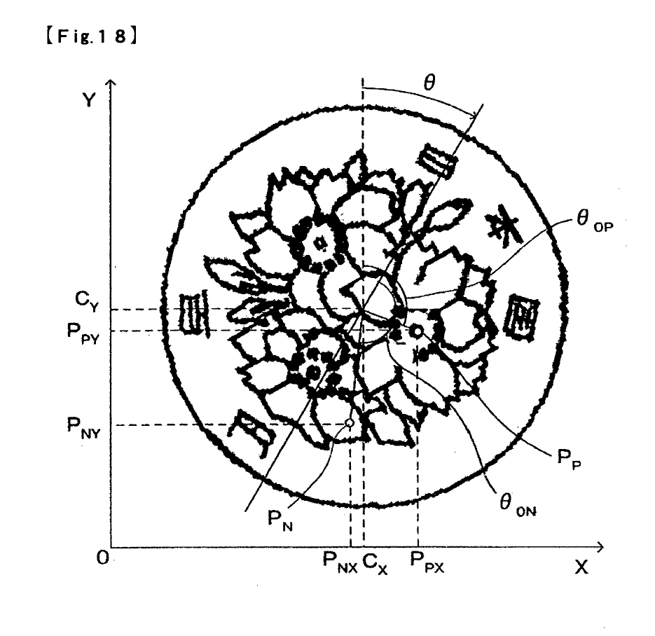

FIG. 19(a) is a view showing a state in which five ring-shaped detection areas are set in a concentrically circular shape and positive windows W_{P} and negative windows W_{N} are set at prescribed positions on the optical image of a 100-yen coin in accordance with a first example of the present invention. In the first example, a setting pattern is selected such that the positive window W_{P1} through the positive window W_{P5} are positioned on the characteristic pattern of a 100-yen coin and the negative window W_{N1} through the negative window W_{N8} are positioned on the non-characteristic portion of the 100-yen coin.

Then, the compression processing is performed in the radial direction at respective cutting-out angles in each of the positive window W_{P1} through the positive window W_{P5} and the negative window W_{N1} through the negative window W_{N8} to create the ring data D (see the step S504 in FIG. 6). The corresponding relationship between the histogram of the ring data D and the respective windows is shown in FIG. 19(b). In FIG. 19(b), the horizontal axis (X-axis) is a detection number (=72 points) in the case of cutting out by the angular pitch of 5 degrees and the vertical axis (Y-axis) is a histogram of the ring data D with respect to the rotation angle. FIG. 19(b) shows that the local maximum values of the ring data D are included in the positive window W_{P1} through the positive window W_{P5} and the local minimum values of the ring data D are included in the negative window W_{N1} through the negative window W_{N8}.

Next, the total sum operation processing (see the step S506 in FIG. 6) and the subtraction processing (see the step S507 in FIG. 6) are performed. The difference data between the total sum value S_{P} of the ring data D in the positive window W _{P1} through the positive window W_{P5} (the value of the ring data D at X=1 in FIG. 19(c)) and the total sum value S_{N} of the ring data D in the negative window W_{N1} through the negative window W_{N8} set in the step S505 in FIG. 6 (the value of the ring data D at X=1 in FIG. 19(d)) are calculated. In other words, the value in which the S_{N} is subtracted from the S_{P} (the value of the ring data D at X=1 in FIG. 19(e)) is calculated.

Next, the ring data D is shifted in the clockwise direction (see the step S508 and the step S509 in FIG. 6) and the total sum value S_{P}, the total sum value S_{N} and the difference data of the ring data D are calculated whenever the ring data D are shifted with the angular pitch of 5 degrees (by one point each in the detection point). Therefore, the respective graphs, i.e., the graph (FIG. 19(c)) showing the total sum value S_{P} with respect to the shifted amount, the graph (FIG. 19(d)) showing the total sum value S_{N} with respect to the shifted amount and the graph (FIG. 19(e)) showing the difference data with respect to the shifted amount, namely the difference data string ΔL are obtained. According to these graphs, the peak value (X=1) in FIG. 19(e) is certainly larger than the peak value (X=1) in FIG. 19 (c) and thus it is understood that the discrimination performance is improved by using the peak value for the identification of genuineness of a circular object.

On the other hand, FIG. 19(f) is a graph showing a corresponding relationship between the histogram of the ring data D and the respective windows obtained from the optical image of the surface of a coin that is to be rejected. Also, FIG. 19(g) is a graph showing the difference data string ΔL obtained from the ring data D shown in FIG. 19(f). In FIG. 19(g), the peak value (=about −500) of the difference data string ΔL is not so large in comparison with the peak value (=about 1800) of the difference data string ΔL shown in FIG. 19(e).

As described above, there is a large difference between the peak value of the difference data string ΔL (FIG. 19(e)) obtained from the ring data D, which is obtained from the optical image of the surface of the coin to be accepted, and the peak value of the difference data string ΔL (FIG. 19(g)) obtained from the ring data D which is cut out from the optical image of the surface of the coin to be rejected. Therefore, the discrimination performance for the genuineness of a circular object that is an object to be identified can be enhanced by utilizing the difference.

### Second Example

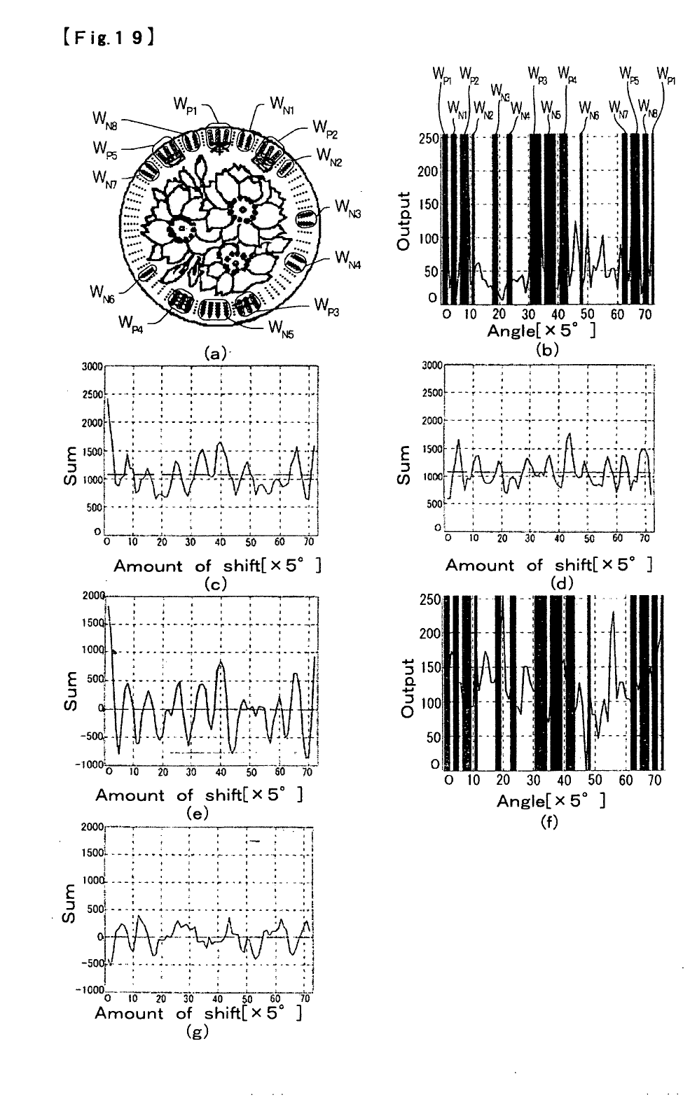

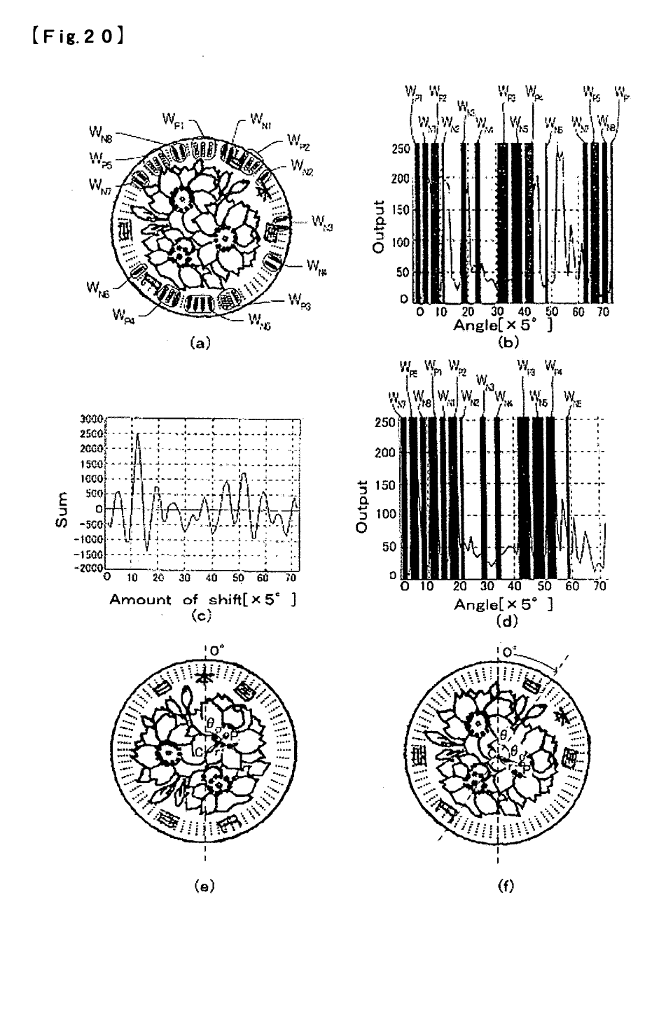

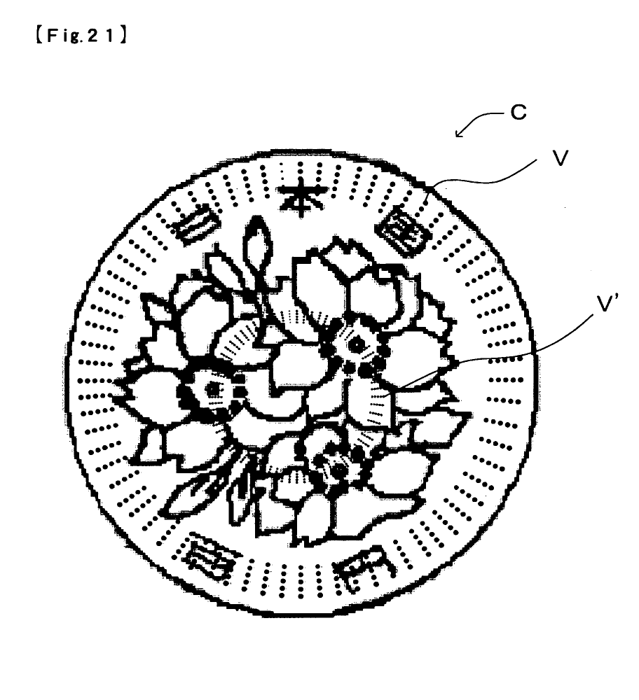

FIG. 20(a) is a view showing a state in which five ring-shaped detection areas are set in a concentrically circular shape and positive windows W_{P} and negative windows W_{N} are set at prescribed positions on the optical image of a 100-yen coin in accordance with a second example of the present invention. In FIG. 20(a), a setting pattern is selected such that the positive window W_{P1} through the positive window W_{P5} are positioned on the characteristic pattern of a 100-yen coin and the negative window W_{N1} through the negative window W_{N8} are positioned on the uncharacteristic portion of the 100-yen coin when the 100-yen coin is shifted by 60 degrees in the counterclockwise direction.

Then, the compression processing is performed in the radial direction at respective cutting-out angles in each of the positive window W_{P1} through the positive window W_{P5} and the negative window W_{N1} through the negative window W_{N8} to create the ring data D (see the step S604 in FIG. 16). The corresponding relationship between the histogram of the ring data D and the respective windows is shown in FIG. 20(b). In FIG. 20(b), the horizontal axis (X-axis) is a detection number (=72 points) in the case of cutting out by the angular pitch of 5 degrees and the vertical axis (Y-axis) is the histogram of the ring data D with respect to the rotation angle. FIG. 20(b) shows that the local maximum values of the ring data D are included in the positive window W_{P1} through the positive window W_{P5} and the local minimum values of the ring data D are included in the negative window W_{N1} through the negative window W_{N8} when the ring data D are shifted by 60 degrees in the leftward (when the 100-yen coin is shifted by 60 degrees in the counterclockwise direction).

Next, the total sum operation processing (see the step S606 in FIG. 16) and the subtraction processing (see the step S607 in FIG. 16) are performed. The difference data between the total sum value S_{P} of the ring data D in the positive window W_{P1} through the positive window W_{P5} and the total sum value S_{N} of the ring data D in the negative window W_{N1} through the negative window W_{N8} set in the step S605 in FIG. 16 are calculated. In other words, the value in which the S_{N} is subtracted from the S_{P} (the value of the ring data D at X=1 in FIG. 20(c)) is calculated.

Next, the ring data D is shifted in the counterclockwise direction (see the step S608 and the step S609 in FIG. 16) and the total sum value S_{P}, the total sum value S_{N} and the difference data of the ring data D are calculated whenever the ring data D are shifted by the angular pitch of 5 degrees (by one point each in the detection point). As a result, the graph showing the data string of the difference data with respect to the shifted amount, namely the difference data string ΔL (FIG. 20(c)) are obtained. According to these figures, the difference data string ΔL certainly exhibits the peak value (=2500) at the point of the peak value (X=12) in FIG. 20(c). Therefore, how many degrees the optical image of the 100-yen coin which is actually picked up is rotated can be acknowledged by calculating the rotation angle corresponding to the peak value of the difference data ΔL. The histogram of the ring data D with respect to the rotation angle (=60 degrees) in this case is shown in FIG. 20(d).

On the other hand, FIG. 20(e) is a view showing the state in which characteristic portions are set on the optical image with both the parameters of the radius distance “r” and the rotation angle θ₀ when a normal 100-yen coin is positioned at a prescribed rotational position (the position where the character of [symbol] is positioned uppermost). The output data in the detected section corresponding to the characteristic portions are specified with the amount parameters of the radius distance “r” and the rotation angle “θ+θ₀” by the calculation of the above-mentioned rotation angle on the optical image which is actually picked up (see FIG. 20(f)).

1. A pattern identification method for identifying a pattern on a surface of an object to be identified, the method comprising analyzing output data based on image data obtained by picking up an image of the pattern of the surface of the object to be identified which is an identification object,
wherein, the pattern identification method further comprises:
previously setting a selection area including a local maximum value or a local minimum value of the output data on the output data;
executing total sum operation processing for obtaining total sum value of the output data in the selection area; and
identifying the pattern on the surface of the object to be identified on the basis of the total sum value.

2. The pattern identification method according to claim 1, wherein identification of the pattern on the surface of the object to be identified is performed by comparing the total sum value with a prescribed threshold value.

3. A pattern identification method comprising picking up an image of a pattern on a surface of an object to be identified which is an identification object, extracting an obtained image data with a prescribed pitch, analyzing output data which are extracted and obtained, and identifying the pattern on the surface of the object to be identified,
wherein, the pattern identification method further comprises:
previously setting a selection area including local maximum values or local minimum values of the output data on the output data;
executing total sum operation processing for obtaining total sum value of the output data in the selection area;
obtaining total sum data string which is data string of the total sum value by executing the total sum operation processing whenever the output data and the selection area are relatively shifted with a prescribed pitch; and
identifying the pattern on the surface of the object to be identified by analyzing the total sum data string.

4. A pattern identification method comprising picking up an image of a pattern on a surface of an object to be identified which is an identification object, extracting an obtained image data with a prescribed pitch, analyzing output data which are extracted and obtained, and identifying the pattern on the surface of the object to be identified,
where, the pattern identification method further comprises:
previously setting a first selection area including a local maximum value of the output data and a second selection area including a local minimum value of the output data on the output data;
executing total sum operation processing for obtaining a first total sum value of the output data in the first selection area and a second total sum value of the output data in the second selection area;
obtaining a first total sum data string which is data string of the first total sum value and a second total sum data string which is data string of the second total sum value by executing the total sum operation processing whenever the output data and the first selection area and the second selection area are relatively shifted with the prescribed pitch;
calculating a difference data string by calculating difference between respective elements of the first total sum data string and respective elements of the second total sum data string corresponding to the respective elements of the first total sum data string; and
identifying the pattern on the surface of the object to be identified by analyzing the difference data string.

5. A pattern identification method comprising picking up an image of a pattern on a surface of a circular object to be identified which is an identification object, setting a ring-shaped detection area concentrically with the circular object to be identified on an obtained image data, and identifying the pattern on the surface of the circular object to be identified by analyzing output data which is obtained by extracting image data in the ring-shaped detection area by a prescribed pitch,
wherein, the pattern identification method further comprises:
previously setting a selection area including a local maximum value or a local minimum value of the output data on the output data;
executing total sum operation processing for obtaining total sum value of the output data in the selection area;
obtaining the total sum data string which is data string of the total sum value by executing the total sum operation processing whenever the output data and the selection area are relatively circulated with the prescribed pitch; and
identifying the pattern on the surface of the circular object to be identified by analyzing the total sum data string.

6. A pattern identification method comprising picking up an image of a pattern on a surface of a circular object to be identified which is an identification object, setting a ring-shaped detection area concentrically with the circular object to be identified on an obtained image data, and identifying the pattern on the surface of the circular object to be identified by analyzing output data which is obtained by extracting image data in the ring-shaped detection area with a prescribed pitch,
wherein, the pattern identification method further comprises:
previously setting a first selection area including a local maximum value of the output data and a second selection area including a local minimum value of the output data on the output data;
executing total sum operation processing for obtaining a first total sum value of the output data in the first selection area and a second total sum value of the output data in the second selection area;
obtaining a first total sum data string which is data string of the first total sum value and a second total sum data string which is data string of the second total sum value by executing the total sum operation processing whenever the output data and the first selection area and the second selection area are relatively shifted with the prescribed pitch;
calculating a difference data string by calculating difference between respective elements of the first total sum data string and respective elements of the second total sum data string corresponding to the respective elements of the first total sum data string; and
identifying the pattern on the surface of the object to be identified by analyzing the difference data string.

7. The pattern identification method according to claim 5, further comprising:
setting a plurality ring-shaped detection areas along a radial direction; and
analyzing a plurality of total sum data strings which are obtained from respective ring-shaped detection areas or a plurality of difference data strings which are obtained from respective ring-shaped detection areas.

8. The pattern identification method according to claim 3, further comprising:
a first step for inputting the total sum data string or the difference data string as specific input data;
a second step for setting a specific selection area including a local maximum value or a local minimum value of the specific input data on the specific input data;
a third step for executing specific total sum operation processing which obtains a specific total sum value of the specific input data in the specific selection area;
a fourth step for obtaining a specific total sum data string which is a data string of the specific total sum value by executing the specific total sum operation processing whenever the specific input data and the specific selection area are relatively shifted with a prescribed pitch; and
after performing the first through the fourth steps, identifying the pattern on the surface of the object to be identified by analyzing the specific total sum data string.

9. The pattern identification method according to claim 8, further comprising:
obtaining the specific total sum data string as the specific input data by repeatedly performing the second step through the fourth step a plurality of times; and
identifying the pattern on the surface of the object to be identified by analyzing the specific total sum data string.

10. The pattern identification method according to claim 3, further comprising:
a first step for inputting the total sum data string or the difference data string as specific input data;
a second step for setting a first specific selection area including a local maximum value of the specific input data and a second specific selection area including a local minimum value of the specific input data on the input data;
a third step for executing a specific total sum operation processing which obtains a first specific total sum value of the specific input data in the first specific selection area and a second specific total sum value of the specific input data in the second specific selection area;
a fourth step for obtaining a first specific total sum data string which is a data string of the first specific total sum value and a second specific total sum data string which is a data string of the second specific total sum value by executing the specific total sum operation processing whenever the specific input data and the first specific selection area and the second specific selection area are relatively shifted with a prescribed pitch;
a fifth step for calculating a specific difference data string by calculating a difference between respective elements of the first specific total sum data string and respective elements of the second specific total sum data string corresponding to the respective elements of the first specific total sum data string; and
after performing the first through the fifth steps, identifying the pattern on the surface of the object to be identified by analyzing the specific difference data string.

11. The pattern identification method according to claim 10, further comprising: obtaining the specific difference data string as the specific input data by repeatedly performing processings from the second step through the fifth step a plurality of times; and
identifying the pattern on the surface of the object to be identified by analyzing the specific difference data string.

12. A pattern identification method comprising:
obtaining the specific total sum data string or the specific difference data string as the specific input data by repeatedly performing a plurality of times processings steps of
setting a specific selection area including a local maximum value or a local minimum value of the specific input data on the specific input data;
executing specific total sum operation processing which obtains a specific total sum value of the specific input data in the specific selection area; and
obtaining a specific total sum data string which is a data string of the specific total sum value by executing the specific total sum operation processing whenever the specific input data and the specific selection area are relatively shifted with a prescribed pitch;
or processings steps off
setting a first specific selection area including a local maximum value of the specific input data and a second specific selection area including a local minimum value of the specific input data on the input data;
executing a specific total sum operation processing which obtains a first specific total sum value of the specific input data in the first specific selection area and a second specific total sum value of the specific input data in the second specific selection area;
obtaining a first specific total sum data string which is a data string of the first specific total sum value and a second specific total sum data string which is a data string of the second specific total sum value by executing the specific total sum operation processing whenever the specific input data and the first specific selection area and the second specific selection area are relatively shifted with a prescribed pitch; and
calculating a specific difference data string by calculating a difference between respective elements of the first specific total sum data string and respective elements of the second specific total sum data string corresponding to the respective elements of the first specific total sum data string; and then
identifying the pattern on the surface of the object to be identified by analyzing the specific total sum data string or the specific difference data string.

13. The pattern identification method according to claim 10, wherein analyzing of the total sum data string, the specific total sum data string, the difference data string or the specific difference data string includes:
detecting a peak value of the total sum data string, the specific total sum data string, the difference data string or the specific difference data string, and
comparing the peak value detected with a prescribed threshold value.

14. The pattern identification method according to claim 13, wherein the analyzing of the total sum data string, the specific total sum data string, the difference data string or the specific difference data string includes:
counting peak values of the total sum data string, the specific total sum data stream, the difference data string or the specific difference data string, and
comparing a total number of which the peak values are counted with a prescribed threshold value.

15. The pattern identification method according to claims 10, wherein the analyzing of the total sum data string, the specific total sum data string, the difference data string or the specific difference data string includes comparing an entire total sum data string, an entire specific total sum data string, an entire difference data string or an entire specific difference data string with a reference total sum data string or a reference difference data string which are previously set.

16. The pattern identification method according to claim 10, wherein the analyzing of the total sum data string, the specific total sum data string, the difference data string or the specific difference data string includes:
detecting a peak value of the total sum data string, the specific total sum data string, the difference data string or the specific difference data string;
obtaining an average value of the total sum data string, the specific total sum data string, the difference data string or the specific difference data string; and
comparing a value, which is subtracted the average value of the total sum data string, the specific total sum data string, the difference data string or the specific difference data string from the peak value of the total sum data string, the specific total sum data string, the difference data string or the specific difference data string, with a prescribed threshold value.

17. A pattern identification method comprising picking up an image of a pattern on a surface of a circular object to be identified which is an identification object, setting a detection area on an obtained image data, and identifying the pattern on the surface of the circular object to be identified by analyzing output data which is obtained by extracting image data in the detection area, wherein the pattern identification method further comprises:
previously setting a characteristic portion peculiar to a prescribed normal circular object when the normal circular object is placed at a prescribed rotation position and the circular object to be identified is the prescribed normal circular object, by using a radius distance “r” from a center position O and a rotation angle θ₀ of the normal circular object;
detecting a rotation angle θ of the circular object to be identified with respect to the prescribed rotation position of the normal circular object; and
identifying the pattern on the surface of the circular object to be identified by analyzing output data specified by the rotation angle θ₀, the radius distance “r” and the rotation angle θ.

18. The pattern identification method according to claim 17, wherein
the characteristic portion includes a first characteristic portion having a characteristic pattern of the normal circular object and a second characteristic portion not having the characteristic pattern of the normal circular object,
difference data between a first output data obtained corresponding to the first characteristic portion and a second output data obtained corresponding to the second characteristic portion are obtained, and
the pattern on the surface of the circular object to be identified is identified by comparing the difference data with a prescribed threshold value.

19. The pattern identification method according to claim 17, wherein a detection method of the rotation angle θ comprises:
previously setting a ring-shaped detection area concentrically with the circular object to be identified on the image data;
previously setting a first selection area including a local maximum value of the output data and a second selection area including a local minimum value of the output data on the output data which are obtained by extracting image data in the ring-shaped detection area by a prescribed pitch;
executing a total sum operation processing for obtaining a first total sum value of the output data in the first selection area and a second total sum value of the output data in the second selection area;
obtaining a first total sum data string which is a data string of the first total sum value and a second total sum data string which is a data string of the second total sum value by executing the total sum operation processing whenever the output data and the first selection area and the second selection area are relatively circulated with a prescribed pitch;
calculating a difference data string by calculating a difference between respective elements of the first total sum data string and respective elements of the second total sum data string corresponding to the respective elements of the first total sum data string; and
detecting the rotation angle by analyzing the difference data string.

20. The pattern identification method according to claim 19, further comprising identifying the pattern on the surface of the circular object to be identified by comparing data added or subtracted the difference data to or from a peak value of the difference data string with a prescribed threshold value.

21. The pattern identification method according to claim 17, wherein the output data are specified while at least one of parameters of the rotation angle θ_{0O}, the radius distance “r” and the rotation angle θ is slightly varied.

22. A pattern identification method according to claim 1, further comprising determining genuineness of an object to be identified or a circular object to be identified.

23. An identification device comprising:
an identification means for identifying a pattern on the surface of an object to be identified or a circular object to be identified;
means for analyzing output data based on image data obtained by picking up an image of the pattern of the surface of the object to be identified which is an identification object,
means for setting a selection area including a local maximum value or a local minimum value of the output data on the output data;
means for executing total sum operation processing for obtaining total sum value of the output data in the selection area; and
means for identifying the pattern on the surface of the object to be identified on the basis of the total sum value.

24. The identification device according to claim 23, further comprising a genuineness decision means for determining genuineness of an object to be identified or a circular object to be identified by an identification result of the identification means.

25. The pattern identification method according to claim 8, wherein analyzing of the total sum data string, the specific total sum data string or the difference data string includes:
detecting a peak value of the total sum data string, the specific total sum data string of the difference data string, and
comparing the peak value detected with a prescribed threshold value.

26. The pattern identification method according to claim 25, wherein the analyzing of the total sum data string, the specific total sum data string or the difference data string includes:
counting peak values of the total sum data string, the specific total sum data stream or the difference data string, and
comparing a total number of which the peak values are counted with a prescribed threshold value.

27. The pattern identification method according to claim 8, wherein the analyzing of the total sum data string, the specific total sum data string or the difference data string includes comparing an entire total sum data string, an entire specific total sum data string or an entire difference data string with a reference total sum data string or a reference difference data string which are previously set.

28. The pattern identification method according to claim 8, wherein the analyzing of the total sum data string, the specific total sum data string or the difference data string includes:
detecting a peak value of the total sum data string, the specific total sum data string or the difference data string;
obtaining an average value of the total sum data string, the specific total sum data string or the difference data string; and
comparing a value, which is subtracted the average value of the total sum data string, the specific total sum data string or the difference data string from the peak value of the total sum data string, the specific total sum data string or the difference data string, with a prescribed threshold value.

29. The pattern identification method according to claim 17, further comprising determining genuineness of an object to be identified or a circular object to be identified.

30. An identification device comprising:
an identification means for identifying a pattern on the surface of an object to be identified or a circular object to be identified;
means for picking up an image of a pattern on a surface of a circular object to be identified which is an identification object;
means for setting a detection area on an obtained image data;
means for identifying the pattern on the surface of the circular object to be identified by analyzing output data which is obtained by extracting image data in the detection area;
means for previously setting a characteristic portion peculiar to a prescribed normal circular object when the normal circular object is placed at a prescribed rotation position and the circular object to be identified is the prescribed normal circular object, by using a radius distance “r” from a center position O and a rotation angle θ of the normal circular object;
means for detecting a rotation angle θ of the circular object to be identified with respect to the prescribed rotation position of the normal circular object; and
means for identifying the pattern on the surface of the circular object to be identified by analyzing output data specified by the rotation angle θ_{O}, the radius distance “r” and the rotation angle θ.

31. The identification device according to claim 30, further comprising a genuineness decision means for determining genuineness of an object to be identified or a circular object to be identified by an identification result of the identification means.
